(19) United States
(12) Patent Application Publication
(10) Pub. No.: US 2026/0170439 A1
(43) Pub. Date: Jun. 18, 2026

(54) OPTIMIZATION PROCEDURES AND MODELS FOR ENHANCING DECARBONIZATION TECHNOLOGY INVESTMENT AND OPERATIONS

(71) Applicant: Schlumberger Technology Corporation, Sugar Land, TX (US)

(72) Inventors: Rodney Lessard, Menlo Park, CA (US); Alaa Eltablawy, Menlo Park, CA (US); Nader Salman, Tomball, TX (US); Clement Zhang, Houston, TX (US); Stephanie Lee, Houston, TX (US)

(21) Appl. No.: 19/417,951

(22) Filed: Dec. 12, 2025

Related U.S. Application Data
(60) Provisional application No. 63/733,570, filed on Dec. 13, 2024.
(60) Provisional application No. 63/762,776, filed on Feb. 25, 2025.
(60) Provisional application No. 63/765,168, filed on Feb. 28, 2025.

(51) Int. Cl. G06Q 10/0637; G06Q 10/04; G06Q 50/02

(52) U.S. Cl. CPC G06Q 10/0637; G06Q 10/04; G06Q 50/02

(57) ABSTRACT

The systems and methods provided herein provide optimization procedures and models for enhancing decarbonization technology investment and operations. For example, an optimization procedure may include selecting a plurality of decarbonization initiatives to consider for implementation for an enterprise; classifying each decarbonization initiative of the plurality of decarbonization initiatives based on one or more decision types; selecting one or more optimization objectives and associated constraints for the plurality of decarbonization initiatives; formulating a unified optimization model based on the one or more optimization objectives and associated constraints; solving the unified optimization model for each decarbonization initiative of the plurality of decarbonization initiatives to determine an optimized decarbonization action plan; and funding and implementing the optimized decarbonization action plan.

### CROSS-REFERENCE TO RELATED APPLICATION

This application claims priority to U.S. Provisional Patent Application Ser. No. 63/733,570, entitled “Optimization Procedures and Models for Enhancing Decarbonization Technology Investment and Operations”, which was filed on Dec. 13, 2024, U.S. Provisional Patent Application Ser. No. 63/762,776, entitled “Multi-Object Optimization Procedure for Decarbonization Technology Investment and Operation”, which was filed on Feb. 25, 2025, and to U.S. Provisional Patent Application Ser. No. 63/765,168, entitled “Optimization Procedures and Models for Enhancing Decarbonization Technology Investment and Operations”, which was filed on Feb. 28, 2025, all of which are herein incorporated by reference in their entireties for all purposes.

### BACKGROUND

This disclosure relates generally to systems and methods for providing optimization procedures and models for enhancing decarbonization technology investment and operations.

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

As hydrocarbons are extracted from hydrocarbon reservoirs via hydrocarbon wells in oil and/or gas fields, the extracted hydrocarbons may be transported to various types of equipment, tanks, processing facilities, and the like via transport vehicles, a network of pipelines, and the like. For example, the hydrocarbons may be extracted from the reservoirs via the hydrocarbon wells and may then be transported, via the network of pipelines, from the wells to various processing stations that may perform various phases of hydrocarbon processing to make the produced hydrocarbons available for use or transport.

The transported hydrocarbons may be processed or refined into suitable hydrocarbon products and ultimately distributed to end consumers. Overall, the hydrocarbon enterprise may be characterized as encompassing upstream, midstream, and downstream stages. At each of these stages, decarbonization parameters such as energy, carbon, waste, water, and the like may be consumed or used. As enterprises move towards becoming more sustainable organizations, it may be challenging to track decarbonization parameters while simultaneously identifying opportunities for improving decarbonization parameters associated with the enterprise. In particular, it may be challenging to evaluate decarbonization parameters implemented as part of the enterprise.

This section is intended to introduce the reader to various aspects of art that may be related to various aspects of the present techniques, which are described and/or claimed below. This discussion is believed to be helpful in providing the reader with background information to facilitate a better understanding of the various aspects of this disclosure. Accordingly, it should be understood that these statements are to be read in this light, and not as admissions of prior art.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In some embodiments, an optimization procedure may include selecting a plurality of decarbonization initiatives to consider for implementation for an enterprise; classifying each decarbonization initiative of the plurality of decarbonization initiatives based on one or more decision types; selecting one or more optimization objectives and associated constraints for the plurality of decarbonization initiatives; formulating a unified optimization model based on the one or more optimization objectives and associated constraints; solving the unified optimization model for each decarbonization initiative of the plurality of decarbonization initiatives to determine an optimized decarbonization action plan; and funding and implementing the optimized decarbonization action plan.

Various refinements of the features noted above may be made in relation to various aspects of this disclosure. Further features may also be incorporated in these various aspects as well. These refinements and additional features may be made individually or in any combination. For instance, various features discussed below in relation to one or more of the illustrated embodiments may be incorporated into any of the above-described aspects of this disclosure alone or in any combination. The brief summary presented above is intended only to familiarize the reader with certain aspects and contexts of embodiments of this disclosure without limitation to the claimed subject matter.

### BRIEF DESCRIPTION OF THE DRAWINGS

Various features, aspects, and advantages of this disclosure will become better understood when the following detailed description is read with reference to the accompanying figures in which like characters represent like parts throughout the figures, wherein:

FIG. 1 illustrates a schematic diagram of example hydrocarbon production system that may include operations undertaken by an enterprise to produce, process, and distribute hydrocarbon products, according to one or more embodiments of this disclosure;

FIGS. 2A through 2F illustrate simplified, schematic views of an oilfield having a subterranean formation containing a reservoir therein, according to one or more embodiments of this disclosure;

FIG. 3 is a data flow diagram in which inputs from data sources are used to generate workflow plans to adjust operations and/or procedures within an enterprise to improve decarbonization parameters, according to one or more embodiments of this disclosure;

FIG. 4 is a block diagram of components that may be part of a decarbonization platform system, according to one or more embodiments of this disclosure;

FIG. 5 illustrates a process for derivation of six initiative types (or classes), each requiring a unique optimization model, according to one or more embodiments of this disclosure;

FIG. 6 illustrates an optimization procedure for determining an optimized decarbonization action plan, according to one or more embodiments of this disclosure;

FIG. 7 illustrates example emissions reduction over time for a plurality of initiatives with hypothetical data, according to one or more embodiments of this disclosure;

FIGS. 8A through 8C illustrate statistical performance benchmarking based on a set of randomized data and increasing number of an initiative type using three different modeling languages, according to one or more embodiments of this disclosure;

FIGS. 9A through 9C illustrate similar statistical performance benchmarking as illustrated in FIGS. 8A through 8C but with equal numbers of multiple initiative types, according to one or more embodiments of this disclosure;

FIG. 10 illustrates a procedure for generating a Pareto front for decarbonization investments that maximizes both net present value (NPV) and total emissions reduction (ER), according to one or more embodiments of this disclosure; and

FIG. 11 illustrates a visualization of the procedure of FIG. 10, according to one or more embodiments of this disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The drawing figures are not necessarily to scale. Certain features of the embodiments may be shown exaggerated in scale or in somewhat schematic form, and some details of conventional elements may not be shown in the interest of clarity and conciseness. Although one or more embodiments may be preferred, the embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to intimate that the scope of the disclosure, including the claims, is limited to that embodiment.

When introducing elements of various embodiments of this disclosure, the articles “a,” “an,” and “the” are intended to mean that there are one or more of the elements. The terms “including” and “having” are used in an open-ended fashion, and thus should be interpreted to mean “including, but not limited to . . . .” Any use of any form of the terms “couple,” or any other term describing an interaction between elements is intended to mean either an indirect or a direct interaction between the elements described.

In addition, as used herein, the terms “real time.” “real-time.” or “substantially real time” may be used interchangeably and are intended to described operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic,” “automatically,” and “automated” are intended to describe operations that are performed or caused to be performed, for example, by a processing/control system (i.e., solely by the processing/control system, without human intervention). In addition, as used herein, the term “approximately equal to” may be used to mean values that are relatively close to each other (e.g., within 5%, within 2%, within 1%, within 0.5%, or even closer, of each other).

Certain terms are used throughout the description and claims to refer to particular features or components. As one skilled in the art will appreciate, different persons may refer to the same feature or component by different names. This document does not intend to distinguish between components or features that differ in name but not function, unless specifically stated.

Hydrocarbon sites may include a number of components that facilitates the extraction, processing, and distribution of hydrocarbons (e.g., oil) from a well or well site. A hydrocarbon extraction site may include different types of facilities and equipment including extraction tools, pipelines, and the like. The operations related to the extraction of the hydrocarbons may often be referred to as upstream operations. After the hydrocarbons are extracted, the raw hydrocarbons may be transported via automobile vehicles, railways, barges, pipelines, or any suitable component to storage containers, processing centers, and the like. In some cases, the raw hydrocarbons may be treated (e.g., waste removed, compressed) prior to being transported to other facilities. These operations are often referred to as midstream operations. Finally, the hydrocarbons may be processed (e.g., refined) and distributed to end consumers, thereby covering downstream operations.

At each stage of operations, a certain amount of greenhouse gas emissions may be produced when performing various tasks associated with each stage. As industries move to providing a net zero carbon enterprise, the greenhouse gas emissions produced during these stages may be removed from the atmosphere. A number of decarbonization action plans may be related to removing carbon from the atmosphere including afforestation, reforestation, soil carbon sequestration, carbon capture and storage technology, direct air capture technology, ocean fertilization, reducing emissions at the source, switching to sustainable power sources, reusing previously discarded resources, and the like. In addition to net zero carbon operations, industries are working to achieve improved decarbonization parameters that reduce waste, conserve resources, and reduce the effects that their respective operations have on the environment.

In order to prepare decarbonization action plans to achieve net zero operations, organizations may first determine baseline decarbonization variable values that reflect the current operations of the entire organization or enterprise. That is, the organization may employ a decarbonization platform system to collect data related to decarbonization parameters from across the entire organization. By way of example, hydrocarbon enterprises may include a number of operations related to the manufacturing, processing, or production of hydrocarbon products. Indeed, hydrocarbon enterprises may involve operations related to upstream, midstream, and downstream operations. As such, to determine the baseline decarbonization parameters, the decarbonization platform system may collect data from sensors, forecasting models, reports, internet-of-things (IOT) devices, image data (e.g., optical gas imaging), flaring control measurements, and other suitable data sources. Using the collected data over time, the decarbonization platform system may determine baseline decarbonization parameters for the entire operational flow of the enterprise over a period of time (e.g., days, weeks, months, years).

Based on the macro outlook of future decarbonization goals as provided by a user, the decarbonization platform system may then employ a planning module to determine decarbonization action plans to determine a number of decarbonization operations to employ to cause the baseline decarbonization parameters to trend towards net zero operations. The planning operations employed by the decarbonization platform system may involve reviewing digital models, empirical models, or insights received from previous operations at facilities other than the respective enterprise to determine operational changes to operations performed within the enterprise, additional operations (e.g., install carbon capture technology) to add to the enterprise, and/or other suitable action plans to cause the enterprise operations to improve decarbonization parameters.

The decarbonization action plans may thus be related to facility level operations that optimize decarbonization efficiencies at a facility level that may involve modifying certain processes (e.g., order of operations and/or timing for performing tasks based on a sustainable energy source schedule). The facilities of an enterprise may be related to buildings in which engineers and office personnel visit, as well as structures that support industrial operations such as production or refining operations. By evaluating the decarbonization parameters with respect to the facility level, the decarbonization platform system may provide decarbonization action plans to coordinate facility operations (e.g., work from home days, lighting operations, operational task schedules, tool selections, equipment operating parameters) to improve decarbonization efficiencies.

In addition, enterprises may perform certain operations to produce or manufacture a product. The decarbonization platform system may also evaluate these product level operations to identify different processes, equipment, or devices to use to improve decarbonization parameters related to the operations that correspond to the operations involved in producing or manufacturing a product. By way of example, a product carbon footprint (PCF) may be generated based on the techniques described herein to illustrate a total of the greenhouse emissions generated by a product over the different stages of its life cycle. For instance, a cradle-grave PCF may include greenhouse emissions from operations related to extraction of raw materials to operations related to the end-of-life of the product.

With the foregoing in mind, the decarbonization platform system may measure the decarbonization parameters for the enterprise at various levels, provide reports related to the measured values, and verify the measurements to ensure that a developed decarbonization action plan, when implemented, may improve decarbonization efficiencies within the enterprise operations. It should be noted that the measured decarbonization parameters may also be sourced or estimated as provided by certain data sources, such as emissions databases provided by EPA, IEA, and the like. In some embodiments, the decarbonization platform system may collect the measured and verified data to provide reports for meeting certain governmental reporting regulations. Further, the decarbonization platform system may model the determined decarbonization action plans to predict the effects to the measured decarbonization parameters over a period of time to determine whether the decarbonization parameters will achieve desired values or ranges.

After generating the decarbonization action plan, the enterprise operations may implement the outlined actions of the decarbonization action plan by adjusting the operations of facilities, the operations of the production services, or the like. As the decarbonization action plan takes effect, the decarbonization platform system may continue to measure, validate, and report the decarbonization parameters that were previously collected to perform feedback analysis to determine the effectiveness of the decarbonization action plan. The results may be stored in a database or other suitable storage component to serve as empirical data for assisting other enterprises achieve their decarbonization goals. Further, the feedback may be provided to the models used to generate the decarbonization action plans to better calibrate certain machine learning parameters or coefficients, such that the models may more accurately reflect the actual measurements.

With the foregoing in mind, the embodiments described herein significantly extend the types of investment decisions that are more suitable for decarbonization investment planning and deliver a more robust economic evaluation potential. In particular, the embodiments described herein provide a set of possible business decisions applied to investment in decarbonization technology and a flexible optimization procedure and unified mathematical model suitable for solving with linear and mixed integer programming methods, which can guide businesses to more cost effective or faster emissions reduction.

The embodiments described herein include a few key building blocks:
1. A decision framework for classifying decarbonization technology investment initiatives aiming at reducing carbon emissions, incorporating a classification scheme based on scalability, expandability and operational flexibility of the technologies;
2. A flexible optimization procedure integrated within the decision framework, employing a unified mathematical model that uses linear and mixed integer programming methods to enhance efficacity of emissions reduction strategies; and
3. A standard benchmarking scheme incorporated into the framework that evaluates the relevance of mathematical programing languages and the integration of solvers in the context of a unified model, ensuring optimal performance of the optimization process in a commercial software product setting.

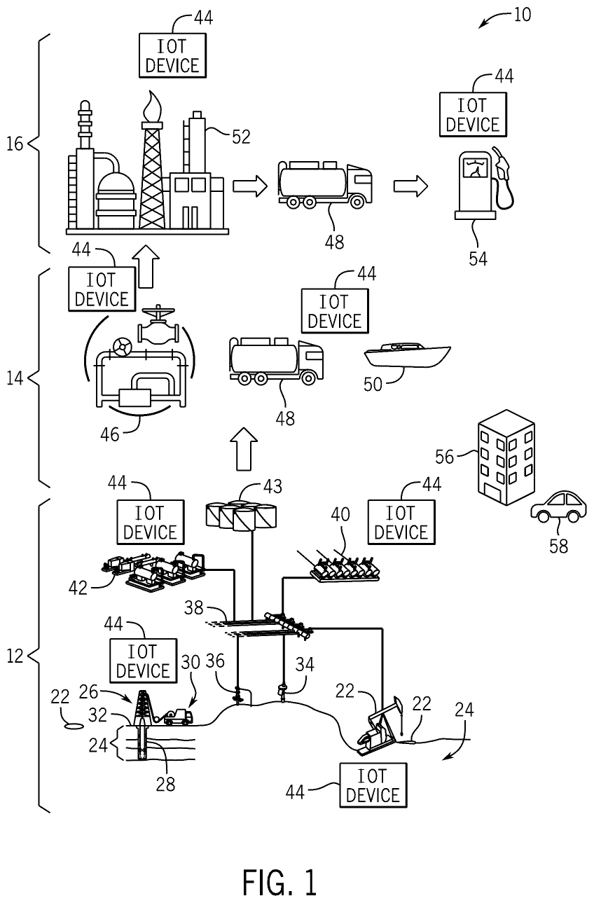

By way of introduction, FIG. 1 illustrates a schematic diagram of an example hydrocarbon production system 10 where hydrocarbon products, such as crude oil and natural gas, may be extracted from the ground, stored, transported, processed, distributed, and the like. The example hydrocarbon production system 10 is provided as an example enterprise that includes a number of different units that coordinate with each other to perform various tasks. For instance, the enterprise may include a collection of equipment, buildings, personnel, raw materials, office buildings, and other components that encompass at least some aspect of the business operations of the enterprise. In the example hydrocarbon production system 10 described below, the enterprise includes all of the processes, employees, operations, buildings, equipment, and other related components that enable the enterprise to produce, transport, and distribute hydrocarbon products. In the same way, the present embodiments described herein may be applied to other enterprises that provide other products and services and should not be limited the hydrocarbon production system 10 described below.

Referring now to FIG. 1, the hydrocarbon production system 10 may generally include an upstream system 12, a midstream system 14, and a downstream system 16. The upstream system 12 may include a number of components and equipment associated with the exploration and production of hydrocarbons. As such, geological surveys that employ seismic sources (e.g., vibrators, air guns), seismic sensors, and other equipment (e.g., fracking trucks) used for hydrocarbon exploration services may be included in the upstream system 12, although not illustrated in FIG. 1.

In addition, the upstream system 12 may include a number of components or facilities that correspond to wells, processing facilities, collection components, distribution networks, and the like. For example, as shown in FIG. 1, the upstream system 12 may include a number of wells 22 disposed within a geological formation 24. The wells 22 may include drilling platform 26 that may have performed a drilling operation (e.g., on land or subsea) to drill out a wellbore 28. Additionally, as used herein, wells 22 may generally refer to physical components such as the drilling platform 26 and wellbore 28 and/or the general area of the reservoir in which extraction is desired (e.g., a reservoir well section). The drilling operations may include drilling the wellbore 28, injecting drilling fluids into the wellbore 28, performing casing operations within the wellbore 28, exploratory operations measuring the viability of the wellbore 28, extraction operations, and the like. In addition to including the drilling platform 26, the upstream system 12 may include surface equipment 30 that may carry out certain operations, such as cement installation operation, well logging operations to detect conditions of the wellbore 28, and the like. As such, the surface equipment 30 may include equipment that store cement slurries, drilling fluids, displacement fluids, spacer fluids, chemical wash fluids, and the like. The surface equipment 30 may include piping and other materials used to transport the various fluids described above into the wellbore 28. The surface equipment 30 may also include pumps, electric or gas-powered motors, and other equipment (e.g., batch mixers, centrifugal pumps, liquid additive metering systems, tanks, etc.) that may be used with or a part of the interior of a casing string with the fluids discussed above.

In addition to the equipment used for drilling operations, the upstream system 12 may include a number of well devices that may control the flow of hydrocarbons being extracted from the wells 22. For instance, the well devices in the upstream system 12 may include pumpjacks 32, submersible pumps 34, well trees 36, and the like. The pumpjacks 32 may mechanically lift hydrocarbons (e.g., oil) out of the well 22 when a bottom hole pressure of the well 22 is not sufficient to extract the hydrocarbons to the surface. The submersible pump 34 may be an assembly that may be submerged in a hydrocarbon liquid that may be pumped. As such, the submersible pump 34 may include a hermetically sealed motor, such that liquids may not penetrate the seal into the motor. Further, the hermetically sealed motor may push hydrocarbons from underground areas or the reservoir to the surface. The well trees 36 may be an assembly of valves, spools, and fittings used for natural flowing wells. As such, the well trees 36 may be used for an oil well, gas well, water injection well, water disposal well, gas injection well, condensate well, and the like. By way of reference, the wells 22 may be part of a first hierarchical level and the well devices that extract hydrocarbons from the wells 22 may be part of a second hierarchical level above the first hierarchical level.

After the hydrocarbons are extracted from the surface via the well devices, the extracted hydrocarbons may be distributed to other devices via a network of pipelines 38. That is, the well devices of the upstream system 12 may be connected together via a network of pipelines 38. In addition to the well devices described above, the network of pipelines 38 may be connected to other collecting or gathering components, such as wellhead distribution manifolds 40, separators 42, storage tanks 43, and the like.

In some embodiments, the pumpjacks 32, the submersible pumps 34, well trees 36, wellhead distribution manifolds 40, separators 42, and storage tanks 43 may be connected together via the network of pipelines 38. The wellhead distribution manifolds 40 may collect the hydrocarbons that may have been extracted by the pumpjacks 32, the submersible pumps 34, and the well trees 36, such that the collected hydrocarbons may be routed to various hydrocarbon processing or storage areas in the upstream system 12, the midstream system 14, or the downstream system 16. The separator 42 may include a pressure vessel that may separate well fluids produced from oil and gas wells into separate gas and liquid components. For example, the separator 42 may separate hydrocarbons extracted by the pumpjacks 32, the submersible pumps 34, or the well trees 36 into oil components, gas components, and water components. After the hydrocarbons have been separated, each separated component may be stored in a particular storage tank 43. The hydrocarbons stored in the storage tanks 43 may be transported via the pipelines 38 to transport vehicles, refineries, and the like.

In addition to the components described above, internet-of-things (IoT) devices 44 may be distributed throughout the upstream system 12, the midstream system 14, and the downstream system 16 and may collect information, perform analysis on data, send data related to a respective component or parameters (e.g., temperature, flow) of a component to a computing system or the like. By way of example, the IoT device 44 may include sensors, actuators, machines, or other equipment that may include a processor that execute computer instructions and performs certain tasks including collecting data, processing data, and communicating data over a network.

After extracting, transporting, and storing the hydrocarbons in the upstream system 12, the hydrocarbons may be transported and stored in the midstream system 14. The midstream system 14 may thus include pipeline infrastructure 46 that may move the extracted hydrocarbons across certain terrains and geographic locations to facilities to process, refine, or store the hydrocarbons. The pipeline infrastructure 46 may include similar devices as described in the upstream system 12 such as the separators 42 and storage tanks 43, as well as other components that may assist in moving the hydrocarbons long distances, such as pumping stations, tank trucks 48, rail tank cars, barges 50, and the like. The IoT devices 44 may thus track the flow of the hydrocarbons, the valves for directing the hydrocarbons within the pipelines, the locations of the vehicles used to transport the hydrocarbons, and the like. In some embodiments, the IoT devices 44 may include autonomous control systems to control the operations of the vehicles transporting the hydrocarbons based, for example, on the decarbonization action plans that are determined as described in greater detail herein.

The downstream system 16 may include components that may convert the transported hydrocarbons into final petroleum or gas products. The operations performed by the downstream system 16 may include refining the hydrocarbons into different products such as gasoline, diesel, oils, lubricants, petrochemicals, and the like. As such, the downstream system 16 may include a refinery system 52 for processing the hydrocarbons. By way of example, the refinery system 52 may include distillation towers to separate the hydrocarbons, heat exchangers to transfer heat between different fluids, pumps used to move fluids, reactors to perform chemical reactions for processing the hydrocarbons, separators 42, compressors, storage tanks, and the like. After the hydrocarbons are converted into hydrocarbon products, they may be transported to other locations for distribution via tank trucks 48 or other suitable distribution mechanisms. For instance, the hydrocarbon products (e.g., gasoline) may be distributed to a fuel station to distribute fuel to consumers via a gas pump 54.

In addition to the upstream system 12, the midstream system 14, and the downstream system 16, the enterprise may include buildings 56, vehicles 58, and other objects that are owned, leased, or operated by an organization. These tangential or supplemental objects may be involved in the planning, marketing, accounting, and supplementary business aspects for commercializing the hydrocarbon production system 10. Although only the buildings 56 and vehicles 58 are depicted as supplementary objects associated with the enterprise in FIG. 1, it should be understood that other supplementary objects may also be considered part of the enterprise.

Each of the components and subsystems of enterprise described above (e.g., the upstream system 12, the midstream system 14, the downstream system 16, office building 56) involves the consumption of resources such as energy and water. Further, these systems also produce a certain amount of waste greenhouse gas (GHG) emissions while performing their respective operations. The resource, waste, and emission amounts vary for different portions of each respective system, but the aggregated resource, waste, and emission amounts may include a planning phase (e.g., within building 56), a construction phase, an operation phase, a decommissioning phase, and the like. In addition, each of these phases at each system level (e.g., upstream, midstream, downstream, office) produces greenhouse gas (GHG) emissions such as carbon dioxide, methane, and the like. The resources, waste, GHG emissions, and other byproducts consumed and produced during these operations may be referred to as decarbonization parameters. Enterprises may generally move to improve decarbonization parameters by focusing on one or more of increasing energy efficiencies, reducing water usage, curbing GHG emissions, decreasing waste amounts, and the like. The decarbonization parameters may be interdependent with each other and the enterprise may reduce the environmental impacts of their operations by coordinating their operations to improve the aggregate decarbonization parameters across the enterprise. As shown in FIG. 1, any type of enterprise may involve a diverse group of equipment, processes, structures, and the like. In accordance with the embodiments described herein, a decarbonization platform system may track and monitor decarbonization parameters across the variety of levels, operations, and aspects of the enterprise to provide decarbonization action plans to revise enterprise operations and structures to improve decarbonization parameters. Indeed, as more industries move to achieve net zero compliance in which the enterprise achieves a balance between the amount of GHG emissions produced by the enterprise operations and removed from the atmosphere, efficient generation of efficient action plans for reduced GHG emissions and other decarbonization operations may be increasingly important.

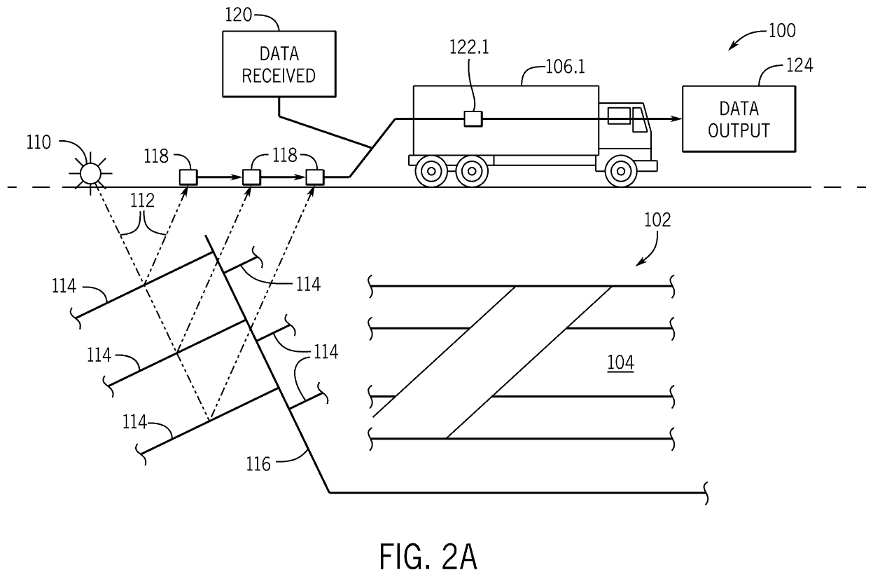

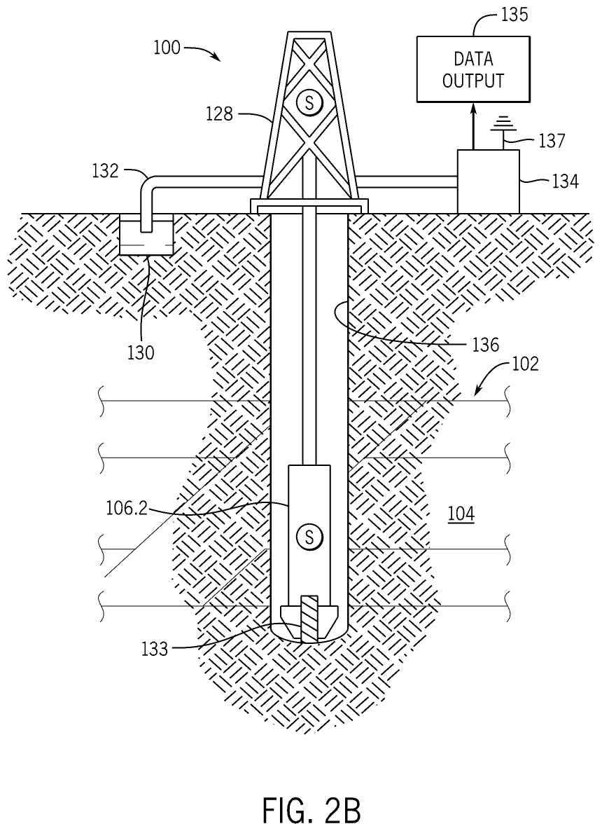

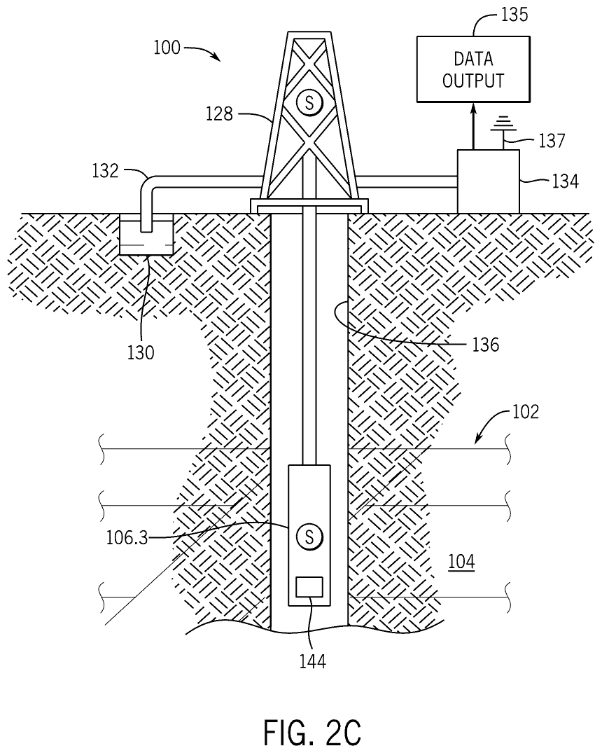

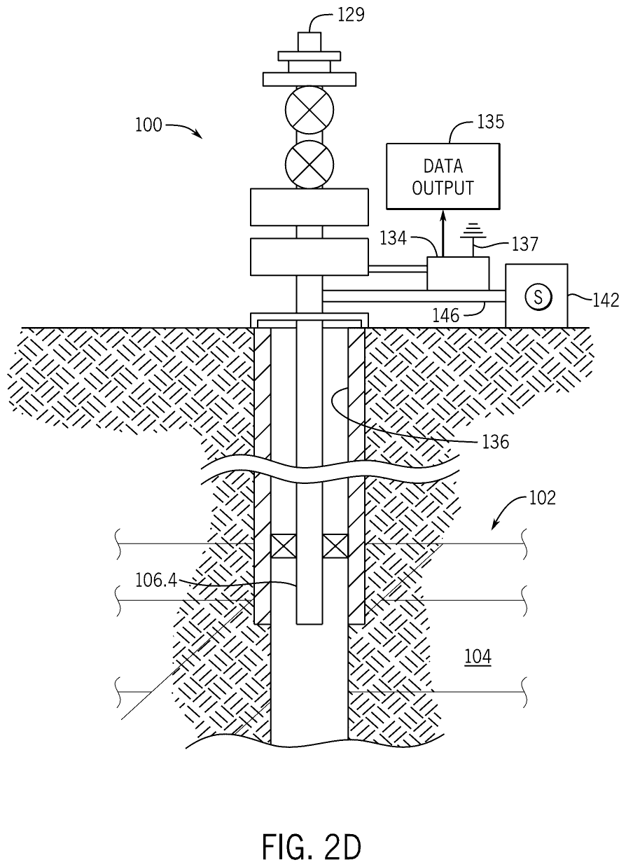

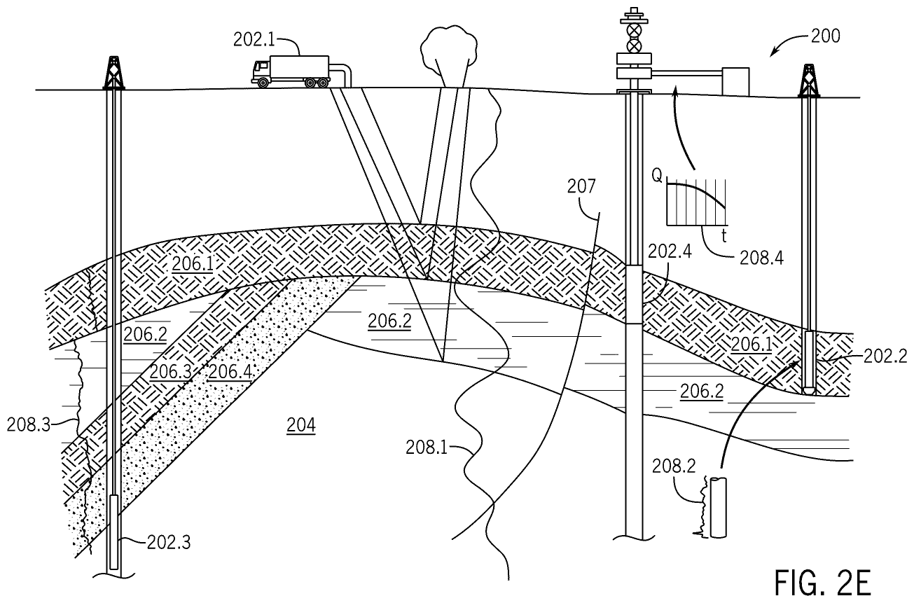

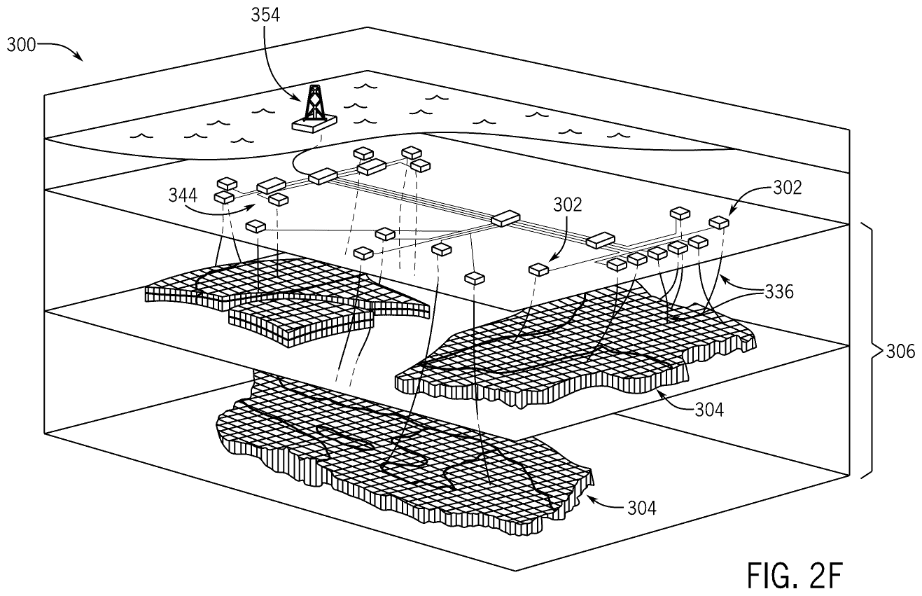

Although the hydrocarbon production system 10 is described above with certain components, it should be understood that the hydrocarbon production system 10 may include additional, fewer, or different components. For example, although discussed above in relation to the hydrocarbon production system 10 on land, present embodiments may also apply to off-shore hydrocarbon sites. Indeed, the hydrocarbon production system 10 may include any number of different systems via which hydrocarbons are extracted. For example, FIGS. 2A through 2F illustrate simplified, schematic views of an oilfield having a subterranean formation containing a reservoir therein. Each of these systems may generate data that is used by a decarbonization platform system to, for example, automatically adjust various plans of the systems to optimize decarbonization efforts for the systems, as described in greater detail herein.

FIG. 2A illustrates a survey operation being performed by a survey tool, such as a seismic truck 106.1, to measure properties of the subterranean formation 102. The survey operation is a seismic survey operation for producing sound vibrations. In FIG. 2A, one such sound vibration, e.g., sound vibration 112 generated by a source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, the computer 122.1 generates seismic data output 124. This seismic data output may be stored, transmitted or further processed as desired, for example, by data reduction.

FIG. 2B illustrates a drilling operation being performed by drilling tools 106.2 suspended by a rig 128 and advanced into subterranean formations 102 to form a wellbore 136. A mud pit 130 is used to draw drilling mud into the drilling tools 106.2 via a flow line 132 for circulating drilling mud down through the drilling tools 106.2, then up the wellbore 136 and back to the surface. The drilling mud is typically filtered and returned to the mud pit 130. A circulating system may be used for storing, controlling, or filtering the flowing drilling mud. The drilling tools 106.2 are advanced into the subterranean formations 102 to reach a reservoir 104. Each well may target one or more reservoirs 104. The drilling tools 106.2 are adapted for measuring downhole properties using logging while drilling tools. The logging while drilling tools may also be adapted for taking a core sample 133 as shown.

Computer facilities may be positioned at various locations about the oilfield 100 (e.g., a surface unit 134) and/or at remote locations. The surface unit 134 may be used to communicate with the drilling tools 106.2 and/or offsite operations, as well as with other surface or downhole sensors. The surface unit 134 is capable of communicating with the drilling tools 106.2 to send commands to the drilling tools 106.2, and to receive data therefrom. The surface unit 134 may also collect data generated during the drilling operation and produce data output 135, which may then be stored or transmitted.

In certain embodiments, one or more IoT devices 44 may be positioned about the oilfield 100 to collect data relating to various oilfield operations as described previously. The IoT device(s) 44 may be positioned in one or more locations in the drilling tools 106.2 and/or at the rig 128 to measure drilling parameters, such as weight on bit, torque on bit, pressures, temperatures, flow rates, compositions, rotary speed, and/or other parameters of the field operation. The IoT device(s) 44 may also be positioned in one or more locations in the circulating system.

The drilling tools 106.2 may include a bottom hole assembly (BHA) (not shown), generally referenced, near the drill bit (e.g., within several drill collar lengths from the drill bit). The bottom hole assembly may include capabilities for measuring, processing, and storing information, as well as communicating with the surface unit 134. The bottom hole assembly further includes drill collars for performing various other measurement functions.

The bottom hole assembly may include a communication subassembly that communicates with the surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore 136 is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. An earth model may also need adjustment as new information is collected.

The data gathered by the IoT device(s) 44 may be collected by the surface unit 134 and/or other data collection sources for analysis or other processing. The data collected by the IoT device(s) 44 may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases or combined into a single database.

The surface unit 134 may include a transceiver 137 to allow communications between the surface unit 134 and various portions of the oilfield 100 or other locations. The surface unit 134 may also be provided with or functionally connected to one or more controllers (not shown) for actuating mechanisms at the oilfield 100. The surface unit 134 may then send command signals to the oilfield 100 in response to data received. The surface unit 134 may receive commands via the transceiver 137 or may itself execute commands to the controller. A processor may be provided to analyze the data (locally or remotely), make the decisions and/or actuate the controller. In this manner, the oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In certain embodiments, well plans may be adjusted to select optimum (or improved) operating conditions, or to avoid problems.

FIG. 2C illustrates a wireline operation being performed by a wireline tool 106.3 suspended by the rig 128 and into the wellbore 136 of FIG. 2B. The wireline tool 106.3 is adapted for deployment into the wellbore 136 for generating well logs, performing downhole tests and/or collecting samples. The wireline tool 106.3 may be used to provide another method and apparatus for performing a seismic survey operation. The wireline tool 106.3 may, for example, have an explosive, radioactive, electrical, or acoustic energy source 144 that sends and/or receives electrical signals to surrounding subterranean formations 102 and fluids therein.

The wireline tool 106.3 may be operatively connected to, for example, geophones 118 and a computer 122.1 of the seismic truck 106.1 of FIG. 2A. The wireline tool 106.3 may also provide data to the surface unit 134. The surface unit 134 may collect data generated during the wireline operation and may produce data output 135 that may be stored or transmitted. The wireline tool 106.3 may be positioned at various depths in the wellbore 136 to provide a survey or other information relating to the subterranean formation 102.

In certain embodiments, one or more IoT devices 44 may be positioned about the oilfield 100 to collect data relating to various field operations as described previously. The IoT device(s) 44 may be positioned in the wireline tool 106.3 to measure downhole parameters which relate to, for example porosity, permeability, fluid composition and/or other parameters of the field operation.

FIG. 2D illustrates a production operation being performed by a production tool 106.4 deployed from a production unit or Christmas tree 129 and into a completed wellbore 136 for drawing fluid from the downhole reservoirs into surface facilities 142. The fluid flows from the reservoir 104 through perforations in the casing (not shown) and into the production tool 106.4 in the wellbore 136 and to surface facilities 142 via a gathering network 146.

In certain embodiments, one or more IoT devices 44 may be positioned about oilfield 100 to collect data relating to various field operations as described previously. The IoT device(s) 44 may be positioned in the production tool 106.4 or associated equipment, such as the Christmas tree 129, the gathering network 146, the surface facility 142, and/or the production facility, to measure fluid parameters, such as fluid composition, flow rates, pressures, temperatures, and/or other parameters of the production operation. Production may also include injection wells for added recovery. One or more gathering facilities may be operatively connected to one or more of the wellsites for selectively collecting downhole fluids from the wellsite(s).

While FIGS. 2B through 2D illustrate tools used to measure properties of an oilfield 100, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. In addition, various IoT device(s) 44 may be located at various positions along the wellbore 136 and/or the monitoring tools to collect and/or monitor the desired data. Other sources of data may also be provided from offsite locations.

The field configurations of FIGS. 2A through 2D are intended to provide a brief description of an example of a field usable with oilfield application frameworks. Part of, or the entirety, of the oilfield 100 may be on land, water, and/or sea. Also, while a single field measured at a single location is depicted, oilfield applications may be utilized with any combination of one or more oilfields 100, one or more processing facilities and one or more wellsites.

FIG. 2E illustrates a schematic view, partially in cross section of an oilfield 200 having data acquisition tools 202.1, 202.2, 202.3 and 202.4 positioned at various locations along the oilfield 200 for collecting data of a subterranean formation 204. The data acquisition tools 202.1-202.4 may be the same as the data acquisition tools 106.1-106.4 of FIGS. 2A through 2D, respectively, or others not depicted. As shown, the data acquisition tools 202.1-202.4 generate data plots or measurements 208.1-208.4, respectively. These data plots are depicted along the oilfield 200 to demonstrate the data generated by the various operations.

The data plots 208.1-208.3 are examples of static data plots that may be generated by the data acquisition tools 202.1-202.3, respectively; however, it should be understood that the data plots 208.1-208.3 may also be data plots that are updated in real time. These measurements may be analyzed to better define the properties of the formation(s) 204 and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths. A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that the oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in the oilfield 200, it will be appreciated that one or more types of measurement may be taken at one or more locations across one or more fields or other locations for comparison and/or analysis.

The data collected from various sources, such as the data acquisition tools of FIG. 2E, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

FIG. 2F illustrates an oilfield 300 for performing production operations in accordance with implementations of various technologies and techniques described herein. As shown, the oilfield has a plurality of wellsites 302 operatively connected to central processing facility 354. The oilfield configuration of FIG. 2F is not intended to limit the scope of the oilfield application system. Part, or all, of the oilfield 300 may be on land and/or sea. Also, while a single oilfield 300 with a single processing facility and a plurality of wellsites 302 is depicted, any combination of one or more oilfields 300, one or more processing facilities and one or more wellsites 302 may be present.

Each wellsite 302 has equipment that forms a wellbore 336 into the earth. The wellbores 336 extend through subterranean formations 306 including reservoirs 304. These reservoirs 304 contain fluids, such as hydrocarbons. The wellsites 302 draw fluid from the reservoirs and pass them to the processing facilities via surface networks 344. The surface networks 344 have tubing and control mechanisms for controlling the flow of fluids from the wellsite to a processing facility 354.

Attention is now directed to methods, techniques, and workflows for planning, forecasting, and/or optimizing production related systems (e.g., model selections, reservoir maps, wells, etc.) in accordance with some embodiments. Some operations in the processing procedures, methods, techniques, and workflows disclosed herein may be combined and/or the order of some operations may be changed. Those with skill in the art will recognize that in the geosciences and/or other multi-dimensional data processing disciplines, various interpretations, sets of assumptions, and/or domain models such as velocity models, may be refined in an iterative fashion; this concept is applicable to the procedures, methods, techniques, and workflows as discussed herein. This iterative refinement can include use of feedback loops executed on an algorithmic basis, such as at a computing device (e.g., a computing system), and/or through manual control by a user who may make determinations regarding whether a given step, action, template, or model has become sufficiently accurate.

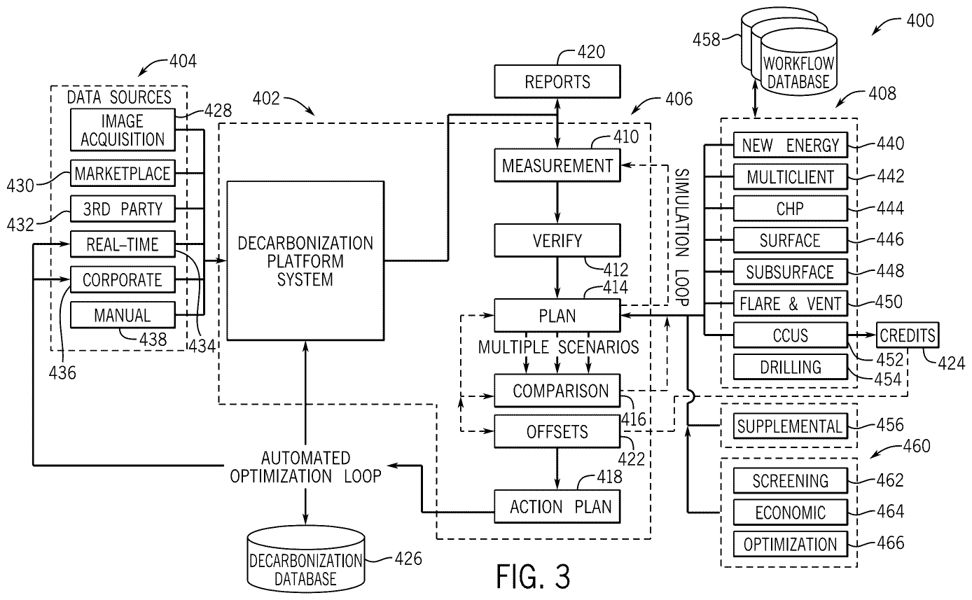

Keeping this in mind, the present embodiments described herein may include systems and methods for improving decarbonization operations across enterprise operations. For example, a data flow diagram 400 of operations performed by a decarbonization platform system 402 is presented in FIG. 3. The data flow diagram 400 may use inputs from data sources to generate decarbonization action plans to adjust operations and/or procedures within an enterprise to improve decarbonization parameters. Although the data flow diagram 400 illustrates a set of input data sources 404, a methodology 406, and a set of engineering workflow systems 408, it should be noted that the elements illustrated in FIG. 3 do not constitute an exhaustive list of elements that may be part of the data flow diagram 400 and used to perform the methods described herein. Instead, the depicted elements are merely provided as examples to provide context and to supplement the explanation of the embodiments described herein.

Referring now to FIG. 3, the decarbonization platform system 402 may include any suitable computing device, cloud-computing device, or the like and may include various components to perform various analysis operations. By way of operation, the decarbonization platform system 402 may receive input data regarding measured decarbonization parameters, policies for decarbonization programs, and other information from a set of input data sources 404. Based on the input data, the decarbonization platform system 402 may perform certain calculations, analyses, or operations to track decarbonization parameters across enterprise operations, report the decarbonization parameters with respect to legislative policies or regulations, identify relationships between operational parameters for facilities, devices, and other components that are part of the enterprise and the measured decarbonization parameters, and the like.

In some embodiments, the decarbonization platform system 402 may implement the methodology 406 that may include a measurement block 410, a verification block 412, a planning block 414, and a comparison block 416. After receiving input data, analyzing the input data with respect to the engineering workflow systems 408, the decarbonization platform system 402 may generate one or more decarbonization action plans 418 that may detail operational changes for facilities, machinery, and the like. After the decarbonization action plans 418 are put in place within the enterprise operations, the decarbonization platform system 402 may again receive the input data to determine the effectiveness of the decarbonization action plans 418, provide improved decarbonization action plans 418, and continuously improve the decarbonization parameters across the enterprise operations for the life of the enterprise.

Generally, the measurement block 410 may receive the input data and store the related measurements, values, and other measurable parameters in a storage component, data store, or the like. In some embodiments, the measurement block 410 may prepare or organize the measurement data in accordance with specific protocols or formats, as defined by reports 420. The reports 420 may include previous reports prepared for different authorities or organizations. As such, the reports 420 may also include metadata related to the format, structure, and type of information presented in the reports 420. In some embodiments, the reports 420, the metadata regarding the reports 420, instructions regarding the preparation or formatting of the reports 420 may also be stored in a database or data storage for access by the decarbonization platform system 402.

The measurement data recorded by the measurement block 410 may be validated by the verification block 412. That is, the verification block 412 may analyze or query other input data to verify that the recorded measurement data is accurate. For example, the measurement block 410 may receive a measurement from the IoT device 44 regarding some decarbonization parameter, such as energy consumption. The verification block 412 may retrieve corporate energy invoices to determine whether the energy consumption measured by the IoT device 44 corresponds to the energy consumed according to the utility providing the energy.

The planning block 414 may use the verified measurement data to query the engineering workflow systems 408 to generate one or more potential decarbonization action plans or scenarios for improving the decarbonization parameters. The engineering workflow systems 408 may include a number of distinct modules or systems that provide recommendations (e.g., equipment recommendation, operational change recommendation) for various portions of the enterprise to improve distinct aspects of decarbonization or gain insight to better determine a plan for improving decarbonization parameters across the enterprise. For instance, the engineering workflow systems 408 may include a new energy system that tracks new energy sources that may be used to meet the energy requests of various portions of the enterprise. The new energy sources may include renewable energy sources to improve the decarbonization parameters for the enterprise operations. As such, the new energy system may determine whether alternative energy sources can be used to replace energy sources that may be less sustainable.

After generating a number of potential plans or scenarios, the comparison block 416 may analyze the collection of potential plans to determine whether plans could be combined, provide comparison data for different decarbonization parameters associated with the generated plans, and the like. Additionally, in some embodiments, an offset block 422 may augment the potential plans to form a decarbonization action plan 418. For example, carbon credits 424 (e.g., purchased or created via carbon capture) may be factored into the comparison and evaluation of potential plans to achieve goals of a decarbonization action plan 418. The comparison data may be presented to a user via an electronic display or any suitable display technology. As should be appreciated, in some embodiments, the comparison block 416 and/or the offset block 422 may be considered part of the plan block 414. In some embodiments, the plans or comparison data may be sent to user devices (e.g., mobile phone) and may cause the user devices to automatically open or execute an application associated with the decarbonization platform system 402, such that the user device presents visualization related to the determined plans, the comparison data, or the like. In some embodiments, the visualizations may be selectable input fields in which the user may touch or select via an input device (e.g., keyboard, mouse). After receiving a selection or acceptance of a decarbonization action plan 418, the decarbonization platform system 402 may send the decarbonization action plan 418 to other user devices, a decarbonization database 426, or other suitable recipient, such that the enterprise may make changes to its operations to implement the recommendations outlined in the decarbonization action plan 418. In some embodiments, the decarbonization platform system 402 may send commands to equipment (e.g., lights, pumps, wellheads, artificial lifts), such as via IoT devices 44, to automatically adjust operational parameters based on the recommended decarbonization action plan 418 to improve the decarbonization parameters associated with the enterprise.

As but one non-limiting example, a decarbonization management module may provide information regarding baseline decarbonization parameters (e.g., carbon footprint, waste levels, water usage), a carbon capture module may provide information regarding current mitigation of decarbonization parameters, and a capital planning module may provide input on the financial constraints and viability of certain actions and/or compliance parameters. Additionally, the decarbonization platform system 402 may identify suitable engineering workflow systems 408 based on the expected outputs provided by those respective systems to generate the decarbonization action plan(s) 418. For example, the decarbonization platform system 402 may utilize different engineering workflow systems 408 to provide instructions or control signals for heat and power operations (e.g., via a combined heat power module), for flaring control (e.g., via a flaring module), for methane control (e.g., via a methane module), and/or for other operations of the enterprise. It should be understood that the decarbonization platform system 402 may coordinate automated control of activities with modules that focus on water, waste, energy, and other suitable decarbonization parameters.

Referring now to the input data sources 404, in some embodiments, the decarbonization platform system 402 may receive data from image acquisition sources 428, marketplace sources 430, third-party sources 432, real-time sources 434, corporate data sources 436, manual sources 438, and the like. The image acquisition sources 428 may include devices that may acquire image data (e.g., pictures, video, infrared image) using any suitable image sensor. As such, the devices may include satellites, drones, infrared sensors, cameras, and the like. The image data provided by the image acquisition sources 428 may correspond to heat dissipating from a device, gas leaking from a device, emissions (e.g., fumes, height of fumes) produced by a device, or any other suitable image data that may provide information related to any suitable decarbonization parameter. In some embodiments, the decarbonization platform system 402 may determine an approximate amount of emissions based on the image data. Although the determined amount may not be precise, the measurement block 410 may use the initial estimate as a data point and use other data points to verify via the verification block 412 using other data.

The marketplace sources 430 may include data provided by analysis software, crowdsourcing systems, and other data sources that may be facilitated by a marketplace such as the Ocean Store provided by Schlumberger and other like sources. That is, the marketplace sources 430 may include data provider sources or services that capture, generate, or simulate certain datasets for use by the decarbonization platform system 402 as ready-made data. For instance, emissions data may be provided by certain marketplace sources 430 that may be able to broadcast or present their available data services for integration with the decarbonization platform system 402 via an integration tool, a network location, the decarbonization platform system 402 itself, or the like. The supplied data (e.g., emissions data) may be incorporated for calculation purposes, analysis purposes, simulation purposes, or the like. Indeed, the data provided via the marketplace sources 430 may include emission factors from various sources such as IPCC, IEA, EIA, and the like, as well as publicly available frameworks such as TCFD, GHG protocol, and the like. In some cases, the marketplace sources 430 may provide data services for a fee (e.g., subscription) and may coordinate data exchange via the decarbonization platform system 402 to enhance the data analysis operations while employing solutions provided by the engineering workflow systems 408 and the like.

As such, different insights with regard to the received data may be determined or gleaned by the decarbonization platform system 402 based on the software modules or solutions provided via the marketplace sources 430. In addition to the examples provided above, the marketplace sources 430 may provide virtual metering data to provide an estimated flow amount for a pump. That is, an application or tool may be provided by the marketplace sources 430 that uses an efficiency of the pump to determine a virtual amount of flow of fluids via the pump based on the amount of time that the pump was operating. Although the present disclosure describes certain exemplary services that may be received via the marketplace sources 430, it should be understood that the marketplace sources 430 may be provided by any suitable application, data system, or other component that may interact and exchange information with the decarbonization platform system 402.

The third-party sources 432 may include supplier information provided by a manufacturer or other entity regarding a device, system, facility, or the like. Using the pump example mentioned above, the third-party sources 432 may provide a datasheet or operational data that details the efficiency, energy consumption rate, and other information related to the operation of the pump. In addition, third-party sources 432 may correspond to data sources that may be utilized by the decarbonization platform system 402 to perform various operations via the planning block 414, in coordination with the engineering workflow systems 408, and the like. By way of example, the third-party sources 432 may include data service providers that perform independent research and business intelligence analysis such as Rystad, Gartner, Statista, and the like. In addition, data projections for different organizations may be provided via the marketplace sources 430 as these organizations acquire these data projections (e.g., OPEX/CAPEX) such as historical emission figures, geographies of areas for operation, number of present facilities, number of fields, and the like. Although the present disclosure describes certain exemplary services that may be received via the third-party sources 432, it should be understood that the third-party sources 432 may be provided by any suitable application, data system, or other component that may interact and exchange information with the decarbonization platform system 402.

The real-time sources 434 may include data provided by sensors, devices, and other data sources via a network connection. As such, the real-time sources 434 may include the IoT devices 44, as well as any smart component that may be part of the enterprise. In addition, the real-time sources 434 may include routers and other data collection point devices that may receive data (e.g., sensor data) from other systems, computing devices, instruments, and the like.

The corporate data sources 436 may include data provided by corporate entities associated with the enterprise or other organization. For instance, many enterprises may use enterprise resource planning (ERP) software systems to assist in coordinating and tracking business operations such as finance, human resources, field operations, manufacturing, production, supply chain, procurement, customer service, and any other suitable business operation. The corporate sources may also include memorandums, company earning reports, decarbonization reports, and other publications provided by the enterprise that may describe various operations, goals, and finances associated with the enterprise. In some embodiments, the corporate data sources 436 may provide an ERP report that details employees that work in a facility, the addresses associated with the employees, the schedules of the employees, the salary information for the employees, the utility invoices for the buildings accessed by the employees, and the like. This information may enable the decarbonization platform system 402 to measure emissions related to the enterprise operations to generate insights regarding priorities to address. Further, the information may be used to provide decarbonization action plans 418 at a facility level, such as recommending changes to work schedules that may encourage work from home days to offset sustainability liabilities in different parts of the enterprise.

The manual sources 438 may include any data manually provide to the decarbonization platform system 402 via user input or the like. For instance, the decarbonization platform system 402 may provide a user interface that solicits inputs from a user regarding various parts of the enterprise operations. The user input may be provided to the decarbonization platform system 402 and used for generating the decarbonization action plans 418 via the methodology 406.

Referring now to the engineering workflow systems 408, the decarbonization platform system 402 may employ one or more of the engineering workflow systems 408, independently or in combination with one or more other systems, to determine recommendations for changing enterprise operations. As used herein, enterprise operations may include any building, operation, task, or activity related to the products and services produced by the enterprise. As such, for example, the enterprise may include any of the activities related to those described above with respect to the hydrocarbon production system 10 from the upstream system to operations related to the function of the building 56. In this way, the decarbonization platform system 402 may holistically evaluate overall decarbonization for the enterprise operations and determine effective and creative solutions to achieve net zero goals.

Each of the engineering workflow systems 408 may perform specific analysis operations to determine solutions for the respective technology areas. That is, the engineering workflow systems 408 may assist with the designing and monitoring of abatement solutions (e.g., emission abatement, waste abatement, etc.). As such, each engineering workflow system 408 may include a separate computing device, cloud system, or the like that independently analyzes data and produces outputs. Each engineering workflow system 408 may thus send queries for information or data to the decarbonization platform system 402, which may serve as data intermediary to assist each engineering workflow system 408 in retrieving relevant information to allow the respective engineering workflow system 408 to perform its analysis. In the same manner, the decarbonization platform system 402 may query one or more engineering workflow systems 408 to retrieve solutions, analysis, recommendations, or the like to determine decarbonization action plans 418 to improve decarbonization parameters. Although the following discussion of the types of the engineering workflow systems 408 include a certain number of systems, it should be noted that additional systems may also be part of the engineering workflow systems 408.

As shown in FIG. 3, the engineering workflow systems 408 may include a new energy system 440, a multiclient system 442, a CHP system 444, a surface system 446, a subsurface system 448, a flare and vent system 450, a CCUS system 452, a drilling system 454, and a supplemental system 456. As mentioned above, each of the engineering workflow systems 408 may coordinate operations with the decarbonization platform system 402 to perform the methodology 406 and generate decarbonization action plans 418. However, by using different modules or systems to analyze different aspects of engineering, the present embodiments described herein enable the decarbonization platform system 402 to preserve computing resources for coordination and integration operations (e.g., collection and transmission of data, organizing plans, coordinating feasibility of different plans for enterprise) between the input data sources 404 and the engineering workflow systems 408 without analyzing different engineering solutions for decarbonization improvements. It should be noted that each of the engineering workflow systems 408 may be complex systems that operate on their own respective platforms (e.g., processing systems, storage components, network connections) to perform various types of data analysis, operations, simulations, and the like. In addition, the output data provided by these engineering workflow systems 408 or used by the same may be stored for use by various entities in workflow databases 458 or other suitable storage component.

By way of example, the new energy system 440 may track, monitor, simulate, and design solutions for various industries to achieve more sustainable energy goals. The new energy system 440 may receive invoice data for energy costs associated with the enterprise (e.g., corporate data source 436), real-time energy usage from IoT devices (e.g., real-time sources 434), and other relevant data regarding the energy consumption data for various aspects of the enterprise. The energy consumption data may include utility provider information that indicates the source of the energy (e.g., coal, renewable), a rate schedule for the provided utilities, and the like. The new energy system 440 may also include databases or storage components that include models that represent other enterprise or facility operations, simulated models generated by artificial intelligence (e.g., neural networks, pattern analysis), machine learning algorithms, or the like. The models or lookup tables may provide information related to the amount of energy provided to different enterprises, the type of energy provided to these enterprises, the costs associated with commissioning these energy sources, and the like. For instance, the new energy system 440 may model the ability of wind farms and solar panel fields to provide energy for one or more facets of a particular enterprise. Alternative sources may also include renewable energy options such as solar power, wind power, hydroelectric power, hydrogen, geothermal energy, biomass, and other suitable alternative energy sources. The model may also include cost projections for commissioning these energy sources, as well as projections over the life of the enterprise. These models may be employed by the decarbonization platform system 402 to determine decarbonization action plans 418 to apply to its respective input data related to the respective enterprise and identify decarbonization action plans 418 that may assist in improving energy decarbonization parameters for the enterprise. In addition to providing alternative energy sources, the new energy system 440 may also provide recommendations with regard to storing energy in batteries, storing hydrogen for later use, storing geothermal energy for use, and the like.

The combined heat and power (CUP) system 444 may perform analysis to determine methods for reusing emissions such as carbon dioxide to increase efficiency. For instance, heat can be recaptured during a portion of a process and the heat can be applied to a heat exchanger to produce energy or perform some other function using the heat recaptured from performing another process within the enterprise. As such, the CHP system 444 may request image data and infrastructure or design data for facilities of the enterprise from the decarbonization platform system 402 to identify process components that may produce heat or power that may be recaptured and recycled for other functions within the enterprise. In any case, the CUP system 444 may help the decarbonization platform system 402 determine decarbonization action plans 418 that improve energy efficiency and reduce facility carbon emissions.

The multiclient system 442 may include data analysis systems from other sources. Indeed, these sources may provide information related to the operations of the enterprise that may be gleaned from the input data received by the decarbonization platform system 402 but may not be determined by the decarbonization platform system 402.

The surface system 446 may include computing systems and databases of information that details operational data regarding various types of equipment that may be installed on the surface of the hydrocarbon production system 10. As such, the surface system 446 may continuously update its data sources to track updated versions of components, identify replacement parts and products for components, track efficiency improvements of components, monitor recalls or issues with installed components, and the like. The surface system 446, for example, may receive real-time data via the decarbonization platform system 402 and determine that certain pieces of equipment are operating inefficiently, are reaching an end of life, has a more energy efficient counterpart available, or the like. The decarbonization platform system 402 may coordinate with the surface system 446 to identify replacements, new components to add to the enterprise, and the like to improve the decarbonization parameters of the enterprise operations.

In the same manner, the subsurface system 448 may include computing systems and databases of information regarding equipment that may be part of subsurface operations in the hydrocarbon production system 10. As such, the subsurface system 448 may provide recommendations with regard to improved data acquisition processes, techniques, equipment, and the like that may enable the enterprise to improve decarbonization parameters. By way of example, the subsurface system 448 may determine improved seismic data acquisition techniques that consume less energy as compared to previous techniques using existing equipment in the enterprise.

The flare and vent system 450 may provide recommendations with regard to flaring and venting excess emissions. In some embodiments, the excess emissions may be captured using carbon capture technology. As such, the flare and vent system 450 may coordinate with the carbon capture (CCUS) system 452 to determine carbon capture technology for storing captured carbon. The CCUS system 452 may provide data regarding costs, installation profile, and operations for carbon technology and recommendations with regard to injecting the captured carbon into appropriate locations. In some embodiments, captured carbon may not be useful for a particular enterprise but may be useful for other enterprises. As such, the CCUS system 452 may identify the industries or organizations that may use the captured carbon in an efficient manner.

The drilling system 454 may provide recommendations with regard to drilling operations for creating boreholes, wells, and the like. The drilling operations may include equipment information, slurry makeup, drilling fluids, water conservation operations, and the like. Further, the supplemental system 456 may include recommendations for other industries, suppliers, distributors, or consumers associated with the enterprise. For instance, the supplemental system 456 may include gasoline distribution facilities with gas pumps 54 that provide gasoline to consumers. The supplemental system 456 may provide information with regard to improving decarbonization parameters for operations that occur between the enterprise associated with the decarbonization platform system 402 and the organization operating the gasoline distribution facilities.

In addition to the engineering workflow systems 408, strategy level planning systems 460 may interact with the decarbonization platform system 402 to perform strategic planning operations for determining decarbonization action plans 418, performing screening analysis, determining economic aspects of the decarbonization action plans 418, determining optimization functions for the decarbonization action plans 418, and the like. That is, the strategy level planning systems 460 may evaluate an organization's decarbonization operations at various hierarchical levels to perform some strategic planning for certain operations, such as performing decarbonization operations. By way of example, the strategy level planning systems 460 may include screening systems 462, economic systems 464, optimization systems 466, and other systems that may analyze the feasibility and viability of implementing certain decarbonization action plans 418.

With this in mind, the strategy level planning systems 460 may perform materiality assessment to provide the enterprise with an opportunity to analyze risks and opportunities associated with implementing the decarbonization action plans 418, and to make any adjustments necessary to improve its business strategy. The assessment helps the organization understand where it is creating or reducing value for society and represents a comprehensive business case to senior executives about why and how to report ESG (environmental, social, governance) data and manage ESG performance. The information obtained and tracked on the platform may essentially help companies in this decision-making process towards their decarbonization strategy. With clear visibility across all three scopes (e.g., environmental, social, governance), materiality assessment would be facilitated. In this way, the strategy level planning system 460 may enable the decarbonization platform system 402 to review decarbonization action plans 418 with respect to government variable, risk management variable, target metrics, and the like.

In some embodiments, the strategy level planning systems 460 may perform evaluation operations based on organizational boundaries and operational boundaries. Organizational boundaries may determine operations that are operated and owned or controlled by the enterprise and thus are included in inventory analysis. The organizational boundaries may account for emissions according to an equity share in the enterprise associated with the respective operations (e.g., equity share approach) or with respect to the aspects of the enterprise that the enterprise may control (e.g., control approach). By way of example, the control approach may include financial control or operational control.

Operational boundaries determine which operations and sources generate emissions, associate sources for inventory, and explanations with regard to how the sources are classified. In some cases, the operational boundaries may attribute emissions as direct emissions and indirect emissions. With this in mind, certain organizations evaluate decarbonization by tracking their emissions effectively as direct emission and indirect emissions. This tracking may help the decarbonization platform system 402 understand hotspots for the enterprise and subsequently develop carbon footprint reduction plans and subsequent business strategy/future investment. In this way, the decarbonization platform system 402 may help companies across a wide range of solutions in the hard-to-abate industries starting from measuring emissions to verifying and reporting. Subsequently, the decarbonization platform system 402 may help them in their decarbonization pathway through the engineering capabilities accessible via the platform as described herein.

In some embodiments, the screening system 462 may perform some technical analysis with respect to overall or high-level system perspectives to determine a relative effectiveness of implementing or conducting decarbonization improvement operations on the enterprise. The screening system 462 may then use the high-level analysis to coordinate with other engineering workflow systems 408 to determine suitable decarbonization action plans 418 that may be beneficial for the enterprise.

In the same manner, the economic system 464 may provide economic or financial data related to the operational costs of the enterprise, economic considerations for improving decarbonization parameters for the enterprise, and the like. In this way, the economic system 464 may provide some insight into economic cost benefits for implementing certain decarbonization action plans 418. In addition, the economic system 464 may coordinate with engineering workflow systems 408 to assess costs for performing certain tasks and/or for determining the economic feasibility of certain decarbonization action plans 418.

The optimization system 466 may determine or analyze optimization parameters for performing certain decarbonization action plans 418. For instance, the optimization system 466 may determine optimization parameters for reducing cost per carbon in decarbonization plans. In any case, the strategy level planning systems 460 may assist the decarbonization platform system 402 to perform economic analysis to perform operations such as selecting decarbonization action plans 418, engaging engineering workflow systems 408, selecting input data sources 404, and the like when determining or implementing decarbonization action plans 418 or performing other suitable operations.

By coordinating the various components described in FIG. 3 and throughout the application, the decarbonization platform system 402 may provide a seamless integration and understanding with ESG scoring and reporting tools, which are designed to assess and measure the sustainability and societal impact of companies and investments. As such, the decarbonization platform system 402 may help organizations evaluate their performance in key ESG areas and provide transparent reporting to stakeholders.

Further, it should be noted that although the embodiments described herein are detailed with respect to existing enterprise operations, in some embodiments, the decarbonization platform system 402 may be used in earlier phases of business development such as field development planning. That is, field development planning may include facility and infrastructure planning operations for building new facilities in various industries. The decarbonization platform system 402 and the methods described herein may be incorporated into the field planning operations to account for decarbonization parameters in the field development plans.

It should be noted that the decarbonization platform system 402 illustrated and described above with respect to FIG. 3 corresponds to one embodiment in which the decarbonization platform system 402 may be implemented. However, the decarbonization platform system 402 may also be implemented in accordance with other structures. For instance, the engineering workflow systems 408 may be part of the decarbonization platform system 402 as a layer for performing analysis operations. The decarbonization platform system 402 may also include other layers of operations such as digital foundation services, data infrastructure, and the like. Moreover, while certain aspects of FIG. 3 are shown as individual elements for data flow purposes, there may or may not be a physical, logical, and/or computational distinction therebetween. For example, in some embodiments, the decarbonization platform system 402 may be considered as distinct from or to include the at least a portion of the engineering workflow systems 408, at least a portion of the decarbonization database 426, at least a portion of the workflow database 458, and/or at least a portion of the input data sources 404.

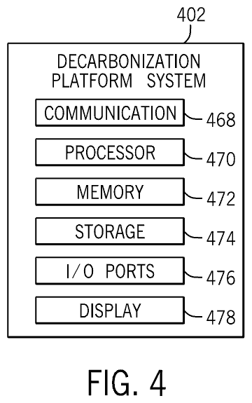

To perform the operations described herein, the decarbonization platform system 402 may include a number of components to assist in processing, analyzing, collecting, and communicating data in accordance with the presently disclosed embodiments. With this in mind, FIG. 3 illustrates example components of the decarbonization platform system 402. As shown in FIG. 4, the decarbonization platform system 402 may include a communication component 468, a processor 470, a memory 472, a storage component 474, input/output (I/O) ports 60, a display 478, and the like. The communication component 468 may be a wireless or wired communication component that may facilitate communication between different monitoring systems, gateway communication devices, various control systems, and the like. The processor 470 may be any type of computer processor or microprocessor capable of executing computer-executable code. The memory 472 and the storage component 474 may be any suitable articles of manufacture that can serve as media to store processor-executable code, data, or the like. These articles of manufacture may represent non-transitory computer-readable media (i.e., any suitable form of memory or storage) that may store the processor-executable code used by the processor 470 to perform the presently disclosed techniques. The memory 472 and the storage component 474 may also be used to store data received via the I/O ports 476, data analyzed by the processor 470, or the like.

The I/O ports 476 may be interfaces that couple to various types of I/O modules such as sensors, programmable logic controllers (PLC), and other types of equipment. For example, the I/O ports 476 may serve as an interface to pressure sensors, flow sensors, temperature sensors, and the like. As such, the planning system 150 may receive data associated with a well via the I/O ports 476. The I/O ports 476 may also serve as an interface to enable the planning system 150 to connect and communicate with surface instrumentation, servers, and the like.

The display 478 may include any type of electronic display such as a liquid crystal display, a light-emitting-diode display, and the like. As such, data acquired via the I/O ports and/or data analyzed by the processor 470 may be presented on the display 478, such that the planning system 150 may present designs for hydrocarbon sites (e.g., of a hydrocarbon production system 10) for view. In certain embodiments, the display 478 may be a touch screen display or any other type of display capable of receiving inputs from an operator. Although the decarbonization platform system 402 is described as including the components presented in FIG. 4, the decarbonization platform system 402 should not be limited to including the components listed in FIG. 4. Indeed, the decarbonization platform system 402 may include additional or fewer components than described above.

As described in greater detail herein, the decarbonization platform system 402 may provide a decision framework for classifying decarbonization technology investment initiatives. The classification scheme within the framework categorizes decarbonization technologies based on their ability to scale operations, expand functional capabilities, and adapt to varying operational conditions. In practice, the framework begins by identifying a set of possible decarbonization technology investment initiatives that when funded, constructed, and operated, will reduce overall net carbon emissions. For example, an initiative could replace a high energy consumption heater to a lower, more energy efficient heater resulting in a net emissions reduction. Another example is switching some portion of electricity usage from grid utilities to a locally installed solar array. These are but a few examples of replacing an existing emissions-generating technology to a lower emissions-generating technology. Another initiative may not replace an existing emissions source, but rather result in a pure net emissions reduction. For example, reforestation or direct air capture.

The decisions of which initiatives to invest in, and when to fund them, depends on the flexibility of the decarbonization technology and the particular need. This flexibility may be summarized based on: (1) whether the decarbonization technology can be scaled, (2) can the decarbonization technology be expanded, once deployed, and (3) can the decarbonization technology be operated at reduced capacity.

### Scalable Decarbonization Technology

A scalable decarbonization technology is a technology with an emissions reduction potential and associated costs that can be scaled continuously from zero to a maximum amount. An example of a scaled decarbonization technology is solar panels. Imagine an area that is available in a favorable location for which solar panels and batteries may be installed to generate and store electricity for particular needs. The area may be filled with solar panels up to the maximum space available or only a fraction of the space available may be filled with solar panels. The decisions may include whether to invest in solar panels at all and, if so, how much of the area to fill with the solar panels, and when should the solar panels be funded (e.g., depending on budget and emissions reduction targets).

### Expandable Decarbonization Technology

Once an initiative is funded and constructed, the initiative may be added to in later years. An example in the context of solar panels may be that, after initial funding and construction of solar panels on a portion of the area, additional panels may be funded and constructed in subsequent years to continue down the path of decarbonization. The initiative may be expanded up to a maximum defined capacity. The decisions may include whether to continue to expand the initiative in future years and, if so, by how much.

### Reducible Operations

The economics of a particular decarbonization technology initiative will include capital spending to purchase materials and equipment and to construct the decarbonization technology, as well as annual costs to operate and maintain the decarbonization technology over its technical lifetime. It may be more cost effective to reduce the operations of an existing decarbonization technology, also reducing its emissions reduction, if doing so results in a lower overall total cost or increase in net value. This possibility is harder to conceive and less likely to occur but if two decarbonization technology initiatives are available, one that is available now but has relatively high operating costs and another one that may not be available for several years and has relatively lower operating costs. If a company must meet an emissions reduction now, they would have to invest in the higher operating cost decarbonization technology now but could also invest in the lower cost decarbonization technology later and reduce the operations of the first decarbonization technology. The balance of how much to reduce operations and replace with the less expensive decarbonization technology is a matter for optimization technology to determine the most efficient balance.

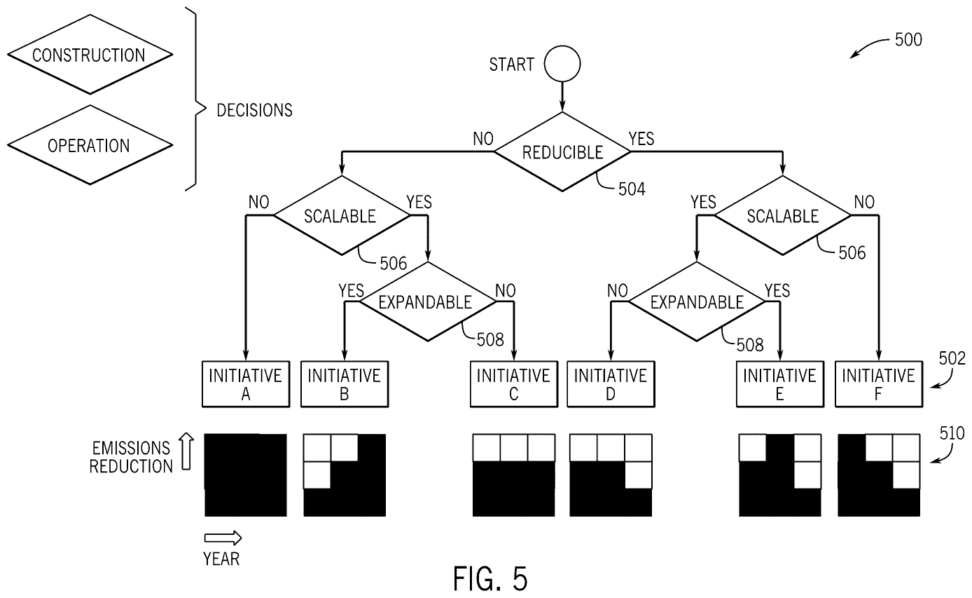

The answers to these three questions result in six different initiative types or classes, as illustrated in FIG. 5, each representing a different set of decisions and, therefore, requiring different optimization models as described below and will be benchmarked individually and in combinations using a benchmarking procedure as also described below to identify the best model and underlying technologies to be used to satisfy production software needs. FIG. 5 illustrates a process 500 for derivation of six initiative types (or classes) 502, each requiring a unique optimization model. As illustrated in FIG. 5, the process 500 may include a plurality of decision blocks relating to the three questions mentioned above, for example, an operation decision block 504 to determine whether a particular decarbonization technology can be operated at reduced capacity, a construction decision block 506 to determine whether the particular decarbonization technology can be scaled, and a construction decision block 508 to determine whether the particular decarbonization technology can be expanded, once deployed. As also illustrated in FIG. 5, each of the initiative types (or classes) 502 may be associated with a simplified summary graph 510 of emissions reduction versus year.

The path towards decarbonization begins with identifying a set of possible initiatives that, if funded, would reduce overall emissions. First, it needs to be decided what investment decisions are possible for each initiative by answering the three questions described above, which will determine the initiative type. Then, an objective and set of constraints may be chosen for the optimization model. The objective is which parameter to maximize or minimize, and the set of constraints define how that choice might be limited by other factors.

In the context of an emissions reduction target, it may be decided that it is desirable to reduce carbon emissions by an increasing target over several years. This is an example of a set of constraints. In general, this should be achieved for the least possible cost. This is the objective. A set of initiative decisions may be found that meets the defined emissions target for the lowest possible cost. Another example is if there is a fixed budget of CAPEX and/or OPEX over the next ten years, which cannot be extended. A set of initiatives may be found that costs less than this budget and maximizes the total emissions reduction in that time period.

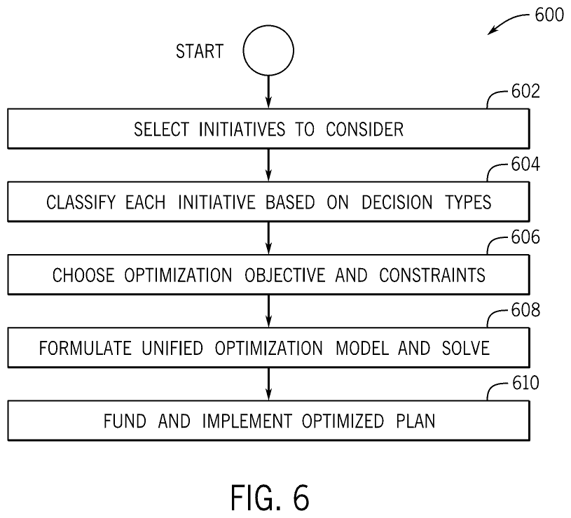

FIG. 6 illustrates an optimization procedure 600 for determining an optimized decarbonization action plan. As illustrated, in certain embodiments, the optimization procedure 600 may begin with selecting initiatives to consider (block 602). Then, each initiative may be classified based on decision types (block 604). Then, one or more optimization objectives and associated constraints may be chosen (block 606). Then, a unified optimization model may be formulated based on the objective(s) and constraints and solved for each initiative to determine an optimized decarbonization action plan (block 608). Then, the optimized decarbonization action plan may be funded and implemented (block 610).

### Optimization Models

Given a classification of an initiative type, as discussed above, an optimization model may be formulated for each initiative type and then the optimization models for the initiative types may be combined them into a unified model based on equivalent objective and constraint functions. Given that many economic and resource functions of interest are linear, a set of linear equations may be derived to model both objective(s) and constraint(s), making it possible to solve the optimization problem with linear and mixed integer programming methods. For example, the total cost of all funded initiatives is the sum of the costs of each initiative. The total emissions reduction from all initiatives is the sum of the emissions reduction of each initiative. The optimization models for initiative types A, B, and C illustrated in FIG. 5 will be derived here. The objective and constraint functions of a mixed set of types A-F may be combined linearly to form a single unified model.

### Initiative Type A

Consider the set of non-scalable, non-reducible initiatives A that can be funded in any one of a set of years

$${Y}_{a}^{f}$$

contained within the plan horizon Y={y₀, . . . , yₕ}. Let SEL_{a,y}_{_{f}}∈{0,1} indicate if initiative a is funded in year y_{f}. Since these initiatives cannot be expanded, it may be assumed that each initiative can only be funded once and runs to completion. Therefore, it may be required that:

$${\sum }_{{y}_{f} ∈ {Y}_{a}^{f}} {SEL}_{a , {y}_{f}} \leq 1 , ∀ a ∈ A$$

An objective function may be formed based on SEL:

$$max {\sum }_{a ∈ A} {\sum }_{{{y}_{f} ∈ {Y}_{f}^{a}}_{}} {g}_{a , {y}_{f}} S E {L}_{a , {y}_{f}}$$

where g are the linear coefficients of the function we wish to optimize. SEL is dimensionless as it only indicates selection of the initiative. Similarly, multiple constraints may be included, generally expressed in the form:

$${\sum }_{a ∈ A} {\sum }_{{{y}_{f} ∈ {Y}_{f}^{a}}_{}} {u}_{a , {y}_{f}} S E {L}_{a , {y}_{f}} \leq {b}_{k} , ∀ k ∈ K$$

where u are the linear coefficient of the function that is desired to constrain to less than value bₖ. In general, “greater than” constraints are easily converted to “less than” constraints by introducing a sign change.

### Initiative Type B

Next, consider the set of scalable initiatives B that can be funded in any one of a set of years

$${Y}_{b}^{f}$$

contained within the plan horizon Y={y₀, . . . , yₕ}. Let CAP_NEW_{b,y}_{_{f}}∈ [symbol] ₊ indicate if new emissions reduction capacity for initiative b is funded in year y_{f}. It may be assumed that each initiative can only be funded to a total maximum emissions reduction capacity CAP_MAX_{b}. Therefore:

$${\sum }_{{{y}_{f} ∈ {Y}_{f}^{a}}_{}} {CAP\_NEW}_{b , {y}_{f}} \leq {CAP\_MAX}_{b} , ∀ b ∈ B$$

An objective may be formed based on CAP_NEW:

$$max {\sum }_{b ∈ B} {\sum }_{{{y}_{f} ∈ {Y}_{f}^{b}}_{}} {g}_{b , {y}_{f}} {CAP\_NEW}_{b , {y}_{f}}$$

where g are the linear coefficients of the function to optimize. CAP_NEW indicates new capacity for emissions reduction, for example, in units of mtCO2e, hence g must be in units per mtCO2e. Multiple constraints may be included, generally expressed in the form:

$${\sum }_{b ∈ B} {\sum }_{{{y}_{f} ∈ {Y}_{f}^{b}}_{}} {u}_{b , {y}_{f}} {CAP\_NEW}_{b , {y}_{f}} \leq {b}_{k} , ∀ k ∈ K$$

where u are the linear coefficient of the function that is desired to constrain to less than value bₖ.

### Initiative Type C

Next, consider the set of scalable initiatives C that can be funded in any one of a set of years

$${Y}_{c}^{f}$$

contained within the plan horizon Y={y₀, . . . , yₕ}. Let CAP_NEW_{c,y}_{_{f}}∈ [symbol] ₊ indicate if new emissions reduction capacity for action c is funded in year y_{f}. Also let SEL_{c,y}_{_{f}}∈{0,1} indicate if action c is funded in year y_{f}. This requires the set of constraints that:

$${CAP\_MAX}_{c} \times S E {L}_{c , {y}_{f}} - {CAP\_NEW}_{c , {y}_{f}} \geq 0 , ∀ c ∈ C , {y}_{f} ∈ {Y}_{c}^{f}$$

It may be assumed that each action can only be funded to a total maximum emissions reduction capacity CAP_MAX_{c} and each action can only be funded once. Therefore:

$${\sum }_{{{y}_{f} ∈ {Y}_{c}^{f}}_{}} SE {L}_{c , {y}_{f}} \leq 1 , and {\sum }_{{{y}_{f} ∈ {Y}_{c}^{f}}_{}} {CAP\_NEW}_{c , {y}_{f}} \leq {CAP\_MAX}_{c} , ∀ c ∈ C ,$$

An objective may be formed based on CAP_NEW:

$$max {\sum }_{c ∈ C} {\sum }_{{{y}_{f} ∈ {Y}_{f}^{c}}_{}} {g}_{c , {y}_{f}} {CAP\_NEW}_{c , {y}_{f}}$$

where g are the linear coefficients of the function to optimize. CAP_NEW indicates new capacity for emissions reduction, for example, in units of mtCO2e. Multiple constraints may be included, generally expressed in the form:

$${\sum }_{c ∈ C} {\sum }_{{{y}_{f} ∈ {Y}_{f}^{c}}_{}} {u}_{c , {y}_{f}} {CAP\_NEW}_{c , {y}_{f}} \leq {b}_{k} , ∀ k ∈ K$$

where u are the linear coefficient of the function that is desired to constrain to less than value bₖ. In general, “greater than” constraints are easily converted to “less than” constraints by introducing a sign change.

### Unified Model

The unified model combines the equations for the objective and constraints for all initiative types into a single set of equations (shown only for types A-C here).

$$max {\sum }_{a ∈ A} {\sum }_{{{y}_{f} ∈ {Y}_{f}^{a}}_{}} {g}_{a , {y}_{f}} SEL {\sum }_{b ∈ B} {\sum }_{{{y}_{f} ∈ {Y}_{f}^{b}}_{}} {g}_{b , {y}_{f}} {CAP\_NEW}_{b , {y}_{f}} + {\sum }_{c ∈ C} {\sum }_{{{y}_{f} ∈ {Y}_{f}^{c}}_{}} {g}_{c , {y}_{f}} {CAP\_NEW}_{c , {y}_{f}}$$

With the constraint:

$${\sum }_{a ∈ A} {\sum }_{{{y}_{f} ∈ {Y}_{f}^{a}}_{}} {u}_{a , {y}_{f}} S E {L}_{a , {y}_{f}} + {\sum }_{b ∈ B} {\sum }_{{{y}_{f} ∈ {Y}_{f}^{b}}_{}} {u}_{b , {y}_{f}} {CAP\_NEW}_{b , {y}_{f}} + {\sum }_{c ∈ C} {\sum }_{{{y}_{f} ∈ {Y}_{f}^{c}}_{}} {u}_{c , {y}_{f}} {CAP\_NEW}_{c , {y}_{f}} \leq {b}_{k} , ∀ k ∈ K$$

### Illustrated Example

The first example assumes a company is value-driven and wishes to maximize the net present value of their decarbonization investments with the constraint that it achieves an emissions reduction target specified for the plan horizon. In this case, the objective is:

$$max {\sum }_{a ∈ A} {\sum }_{{{y}_{f} ∈ {Y}_{f}^{a}}_{}} NP {V}_{a , {y}_{f}} S E {L}_{a , {y}_{f}} + {\sum }_{b ∈ B} {\sum }_{{{y}_{f} ∈ {Y}_{f}^{b}}_{}} {NPVI}_{b , {y}_{f}} {CAP\_NEW}_{b , {y}_{f}} + {\sum }_{c ∈ C} {\sum }_{{{y}_{f} ∈ {Y}_{f}^{c}}_{}} NPV {I}_{c , {y}_{f}} {CAP\_NEW}_{c , {y}_{f}}$$

where NPV_{a,y}_{_{f}} is the net present value of the investment in initiative a if it were funded in year y_{f}. For initiative types b and c, NPVI is the scaled net present value in currency per unit of emissions reduction ($/mtCO2e). It may be assumed that the plan horizon comprises years Y={y₀, y₁, . . . yₓ₋₁}. Then, K constraints may be required of the form:

$${\sum }_{a ∈ A} {\sum }_{{{y}_{f} ∈ {Y}_{f}^{a}}_{}} {ER}_{a , {y}_{k} , {y}_{f}} S E {L}_{a , {y}_{f}} + {\sum }_{b ∈ B} {\sum }_{{{y}_{f} ∈ {Y}_{f}^{a}}_{}} {EPM}_{b , {y}_{k} , {y}_{f}} {CAP\_NEW}_{b , {y}_{f}} + {\sum }_{c ∈ C} {\sum }_{{{y}_{f} ∈ {Y}_{f}^{c}}_{}} ER {M}_{c , {y}_{k} , {y}_{f}} {CAP\_NEW}_{c , {y}_{f}} \geq E R {T}_{k}$$

where ER_{a,y}_{ₖ}_{,y}_{_{f}} is the emission reduction resulting from initiative a in year yₖ if it were funded in year y_{f}. For initiative types b and c, CAP_NEW is the emissions reduction and ERM is an emissions reduction mask that is 0 during construction periods and 1 otherwise. ERTₖ is the emissions reduction target in year yₖ.

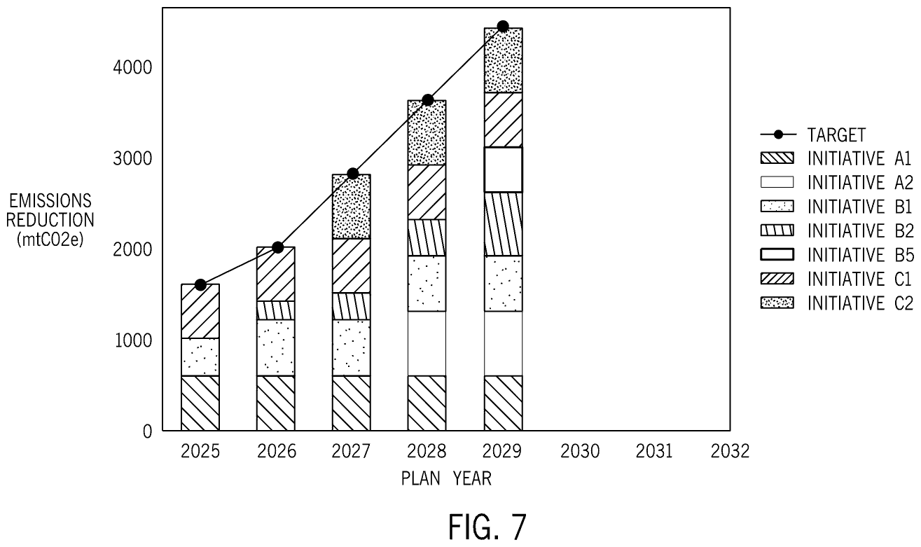

The results of solving these equations with mixed integer programming methods are a set of decisions. FIG. 7 illustrates example emissions reduction over time for a plurality of initiatives from the example discussed above, with hypothetical data. It may be assumed that five initiatives each of types A, B, and C are used. The net present value of each initiative is computed as NPV=−400, −600, −900, −1000 and −1200 in some currency unit. The negative sign means they cost more than they save or generate revenue. The corresponding maximum emissions reduction per year is ER=600, 700, 750, 800 and 1200 and the company wishes to reduce their total emissions over the next 5 years by ERT=800, 1000, 1400, 1800 and 2200. This problem is formulated as above and solved with mixed integer programming techniques to yield an optimum solution shown below.

The interpretation of the results illustrated in FIG. 7 is as follows:
2025: Invest in initiative A1 (A1 is not scalable, so the full amount must be invested), some of initiative B1 (B1 is scalable, so a choice may be made whether to fund only part of it) and all of initiative C1 (C1 is scalable but, once funded, cannot be expanded).
2026: B1 may be expanded to its maximum capacity and some of initiative B2 may be added.
2027: B2 may be expanded and all of C2 may be added.
2028: B2 may be expanded again and all of initiative A2 may be invested in.
2029: B2 may be expanded to its full capacity and just enough of B5 may be added to meet the emissions target.

Making these decisions ensures a maximum total net present value while meeting the emissions reduction target as shown in the plot illustrated in FIG. 7.

### Benchmarking Framework

The optimization procedure, as illustrated in FIG. 6, involves formulating an optimization model and solving it to obtain an optimal decarbonization action plan. However, a practical challenge remains in ensuring that the optimal decarbonization action plan is computed at a reasonable cost (e.g., taking into account infrastructure/licenses). While solving the optimization problem for some initiative classes is relatively straightforward using mathematical languages and solvers. However, others present unique challenges including, but not limited to:
1. Cost considerations: For many initiative classes, the compute cost is relatively minimal, primarily associated with cloud infrastructure and the time needed to run this infrastructure to resolve the problem.
2. Complexity for some initiatives: For other initiatives (e.g., Type C), the computational complexity increases significantly, making the choice of underlying technologies critical for implementing models or unified models effectively.

The choice of underlying technologies impacts software implementation decisions in terms of:
1. Performance and optimization: Selecting technologies that optimize performance while minimizing cost is essential for achieving deployment of an efficient production solution to solve the unified model.
2. Scalability and flexibility: Technology choices must support scalability and flexibility to adapt to a variety of initiative types and number of initiatives ensuring long term viability of the solution.

The benchmarking framework is designed to evaluate and compare different technologies from the most granular initiative type to the more complex combination of initiative types. The framework is designed to be highly customizable, allowing users to tailor it and integrate with various data sizes and input parameters as well as support different mathematical languages and underlying solvers.

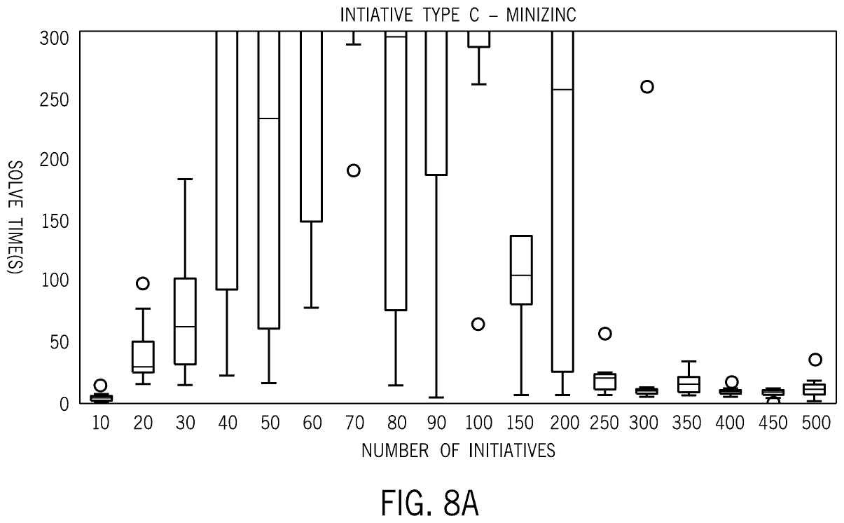

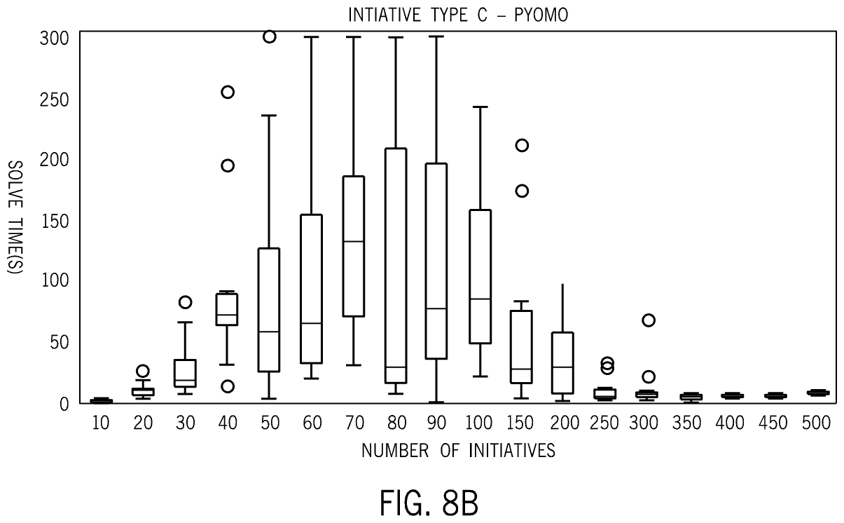

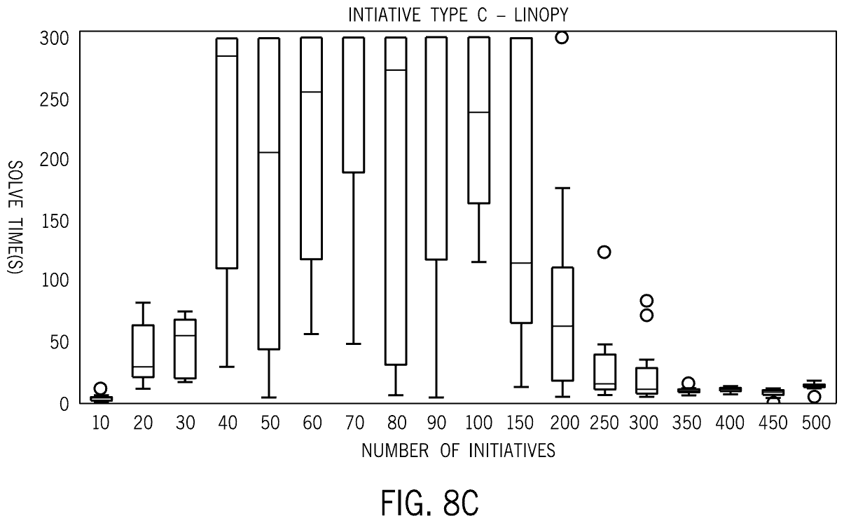

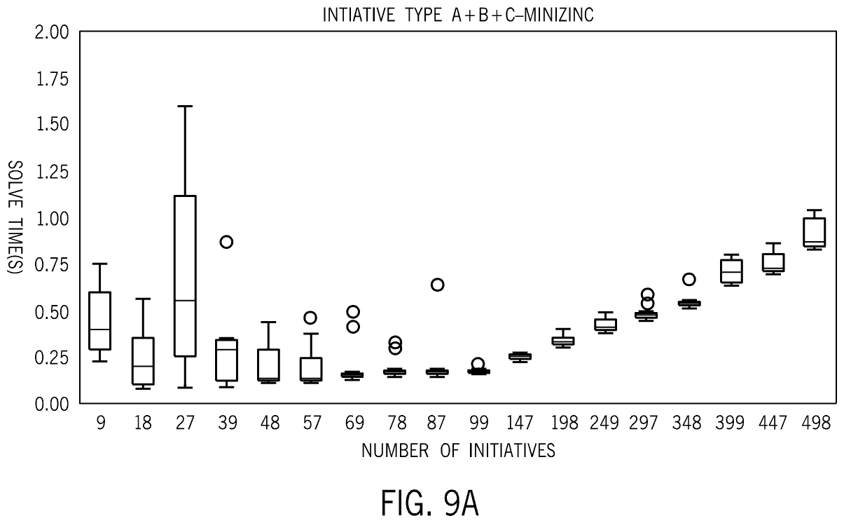

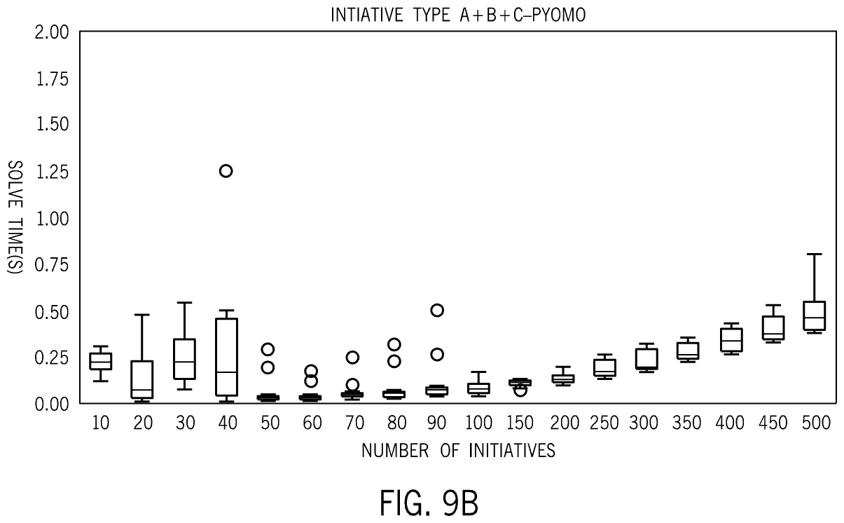

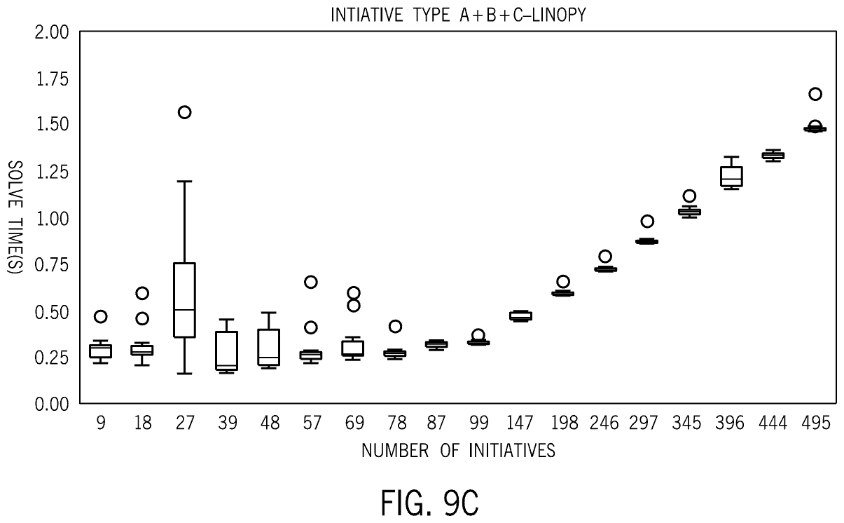

The framework will run automatically and generate the resulting plots illustrated in FIGS. 8A through 8C and FIGS. 9A through 9C to identify the most effective solution to integrate as part of our commercial software offering by:
1. Assessing performance metrics: The framework measures performance based on model solve time vs the number of initiatives. This allows for the automatic identification of the most efficient solution by analyzing output distribution (or narrowing down to a smaller set of viable solutions).
2. Guiding design decisions: The framework runs tests to better understand timeouts and other critical factors influencing technology choices.
3. Facilitating informed decision making: The framework enables informed decisions by offering a comprehensive understanding of the trade-offs involved in different technology implementations.

In practice, the framework automatically generates a set of random yet representative inputs spanning one to hundreds (e.g., as defined by a user), defines a hardware target (e.g., cloud server, local machine, and so forth), and sets input parameters tied to the decarbonization action plan as well as ones influencing the underlying solver technologies. Once fixed, the benchmarking framework runs through all combination of technologies provided (and supported by the framework) including mathematical languages (ex: MiniZinc, Pyomo, Linopy) and their underlying solvers (HiGHS, CBC) and produces benchmarking results as illustrated in FIGS. 8A through 8C and 9A through 9C.

In particular, FIGS. 8A through 8C illustrate statistical performance benchmarking based on a set of randomized data and increasing number of initiative type C using three different modeling languages (MiniZinc, Pyomo, and Linopy) and, in this case, the HiGHS solver. In these “box and whisker plots”, the boxes represent the span between the 1st and 3rd quartile of the model solve times, while the lines and bars (the whiskers) represent the upper and lower bounds of the distribution. Open circles are points deemed to fall outside the distributions and considered outliers. FIGS. 9A through 9C illustrate similar statistical performance benchmarking but with equal numbers of initiative types A, B, and C.

Following a run of benchmarking and the generation of outputs, an interpretation is provided based on key factors such as distribution of outputs, number of failures of one stack, and so forth. This narrows down the selection of technologies. The framework also provides a means to run the benchmarking multiple times to understand timeouts of underlying solvers and identify and identify the most efficient solutions. It should be noted that the benchmarking may also be integrated into CI/CD pipelines to make sure regressions do not occur with future code changes. In certain embodiments, the selection of technologies to be used to solve the unified optimization model described herein for a plurality of decarbonization initiatives to determine an optimized decarbonization action plan may be performed automatically (e.g., without human intervention) by the processing/control system performing the solving of the unified optimization model. As such, the process of determining the optimized decarbonization action plan may be self-improving insofar as the processing/control system may be capable of automatically improving the process of solving the unified optimization model.

The path towards a balanced planet is challenged by the enormous investment needed to transition energy production and consumption from carbon emitting technologies to carbon free, or at least dramatically less carbon emitting technologies. This transition will take years and will require significant investment that is affordable, perhaps even profitable, and meet the urgency of net zero carbon emission goals needed to reduce the impact of climate change.

Fortunately, there are an increasing number of carbon reducing technologies, each with different costs, decarbonization potential and ability to scale. Embodiments described herein include a method to compare and optimize multiple objectives for investment planning and operational control of decarbonization technologies. Investment decisions for decarbonization technology are often driven by more than one objective and there is need to understand the trade-offs between them to aid an informed decision.

A simple example is the trade-off between the net present value (NPV) of a set of decarbonization technology investments, called a plan, and the total amount of emissions reduction (ER) they generate. One could arbitrarily set a minimum total emissions reduction target and find the plan that maximizes NPV or, vice versa, set a spending limit and find a set of decarbonization technologies that maximizes the total emissions reduction. However, neither of these would inform the user whether a small increase (or decrease) in spending could have a relatively large increase (or small decrease) in emissions reduction. For this kind of analysis, the trend of maximum NPV versus the best achievable total emissions reduction needs to be known. This kind of trend is known as a Pareto front and embodiments described herein include a procedure to generate it.

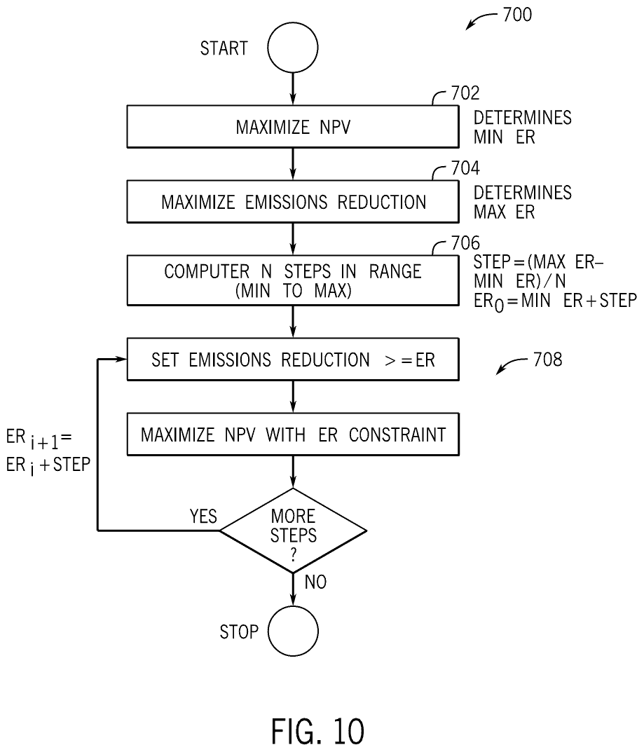

FIG. 10 illustrates a procedure 700 for generating a Pareto front for decarbonization investments that maximizes both NPV and total emissions reduction (ER). As illustrated, in certain embodiments, the procedure 700 may begin with finding a first plan that maximizes the NPV of the selected technologies (block 702). As illustrated, in certain situations, the procedure 700 may not start with a first plan that maximizes total emissions reduction as this would not be of interest. In particular, a first plan may be selected that generates less emissions reduction for greater NPV, which any rational investor would prefer. From the first plan that maximizes NPV, a corresponding lower bound of emissions reduction may be determined. Next, a second plan that maximizes emissions reduction may be found (block 704). Together, these two plans provide lower and upper bounds of emissions reduction, which may be subdivided into a number of emissions reduction target steps (block 706). For each emissions reduction step, a plan that maximizes NPV for the same or greater emissions reduction target may be found (compute loop 708).

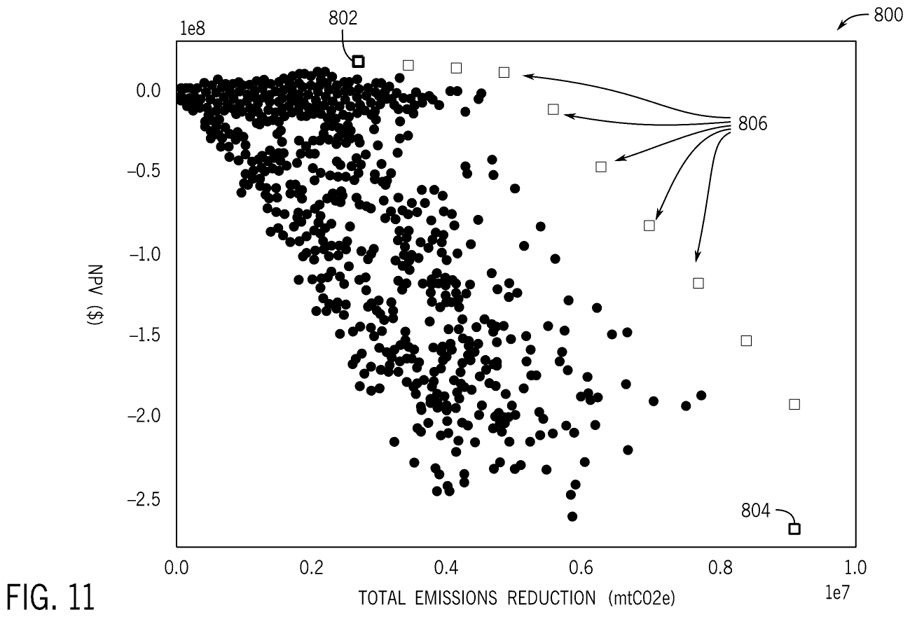

FIG. 11 illustrates a visualization of the procedure 700 of FIG. 10. In particular, FIG. 11 illustrates a Pareto front 800 for NPV and total emissions reduction. The myriad circles are randomly generated plans to illustrate the range of possible outcomes. The top square 802 is the Max NPV plan (Min ER). The bottom square 804 is the Max ER plan. The plurality of other squares 806 are the generated points along the Pareto front that maximize NPV for emissions greater than or equal to the x-axis value. The Pareto front 800 displayed in FIG. 11 shows an interesting range where only a small increase in cost results in significant emissions reduction but that, after about 5 MmtCO2e, investment must be substantially increased. A budget constrained business may prefer to start here in the planning cycle before taking on greater investment. The same procedure 700 illustrated in FIG. 11 may be used for other types of objective trade-offs, for example, value and risk in which case the Pareto front 800 is known as an Efficient Frontier.

Reference throughout this specification to “one embodiment,” “an embodiment,” “embodiments,” “some embodiments,” “certain embodiments,” or similar language means that a particular feature, structure, or characteristic described in connection with the embodiment may be included in at least one embodiment of this disclosure. Thus, these phrases or similar language throughout this specification may, but do not necessarily, all refer to the same embodiment. Although this disclosure has been described with respect to specific details, it is not intended that such details should be regarded as limitations on the scope of this disclosure, except to the extent that they are included in the accompanying claims.

Additionally, the methods and processes described above may be performed by a processor. Moreover, the term “processor” should not be construed to limit the embodiments disclosed herein to any particular device type or system. The processor may include a computer system. The computer system may also include a computer processor (e.g., a microprocessor, microcontroller, digital signal processor, or general-purpose computer) for executing any of the methods and processes described above.

The computer system may further include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

Some of the methods and processes described above, can be implemented as computer program logic for use with the computer processor. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the computer processor. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web).

Alternatively or additionally, the processor may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

While the embodiments set forth in this disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

What is claimed is:

1. A method, comprising:
selecting, via a computing system, a plurality of decarbonization initiatives to consider for implementation for an enterprise;
classifying, via the computing system, each decarbonization initiative of the plurality of decarbonization initiatives based on one or more decision types;
selecting, via the computing system, one or more optimization objectives and associated constraints for the plurality of decarbonization initiatives;
formulating, via the computing system, a unified optimization model based on the one or more optimization objectives and associated constraints;
solving, via the computing system, the unified optimization model for each decarbonization initiative of the plurality of decarbonization initiatives to determine an optimized decarbonization action plan; and
funding and implementing, via the computing system, the optimized decarbonization action plan.

2. The method of claim 1, comprising:
performing, via the computing system, a benchmarking process to evaluate a plurality of mathematical programming languages and solvers in the context of the unified optimization model to automatically select a mathematical programming language and solver; and
selectively using, via the computing system, the selected mathematical programming language and solver to solve the unified optimization model for each decarbonization initiative of the plurality of decarbonization initiatives to determine the optimized decarbonization action plan.

3. The method of claim 1, wherein the plurality of decarbonization initiatives each define a particular decarbonization technology investment initiative to be funded to provide one or more particular carbon emissions reductions to reduce overall net carbon emissions for the enterprise.

4. The method of claim 1, wherein each of the one or more decision types define:
whether the respective decarbonization initiative can be scaled;
whether the respective decarbonization initiative can be expanded, once deployed; and
whether the respective decarbonization initiative can be operated at reduced capacity.

5. The method of claim 1, comprising solving, via the computing system, the unified optimization model for each decarbonization initiative of the plurality of decarbonization initiatives utilizing linear and mixed integer programming methods.

6. The method of claim 1, wherein the unified optimization model is defined by a set of linear equations to model the one or more optimization objectives and associated constraints.

7. The method of claim 1, wherein solving, via the computing system, the unified optimization model for each decarbonization initiative of the plurality of decarbonization initiatives comprises determining a net present value and maximum emissions reduction of each decarbonization initiative over a time period.

8. The method of claim 7, comprising generating a decarbonization investment Pareto front for multiple objectives comprising:
maximizing, via the computing system, the net present value of each decarbonization initiative to determine a corresponding lower bound of emissions reduction;
determining, via the computing system, a decarbonization action plan that maximizes emissions reduction to determine a corresponding upper bound of emissions reduction;
sub-dividing, via the computing system, the lower and upper bounds of emissions reduction into a number of emission reduction target steps; and
for each emissions reduction target step, determining, via the computing system, a decarbonization action plan that maximizes net present value for a same or greater emissions reduction target.

9. A system, comprising:
a computing system comprising one or more processors and a memory configured to store instructions that, when executed by the one or more processors, cause the computing system to perform operations comprising:
selecting a plurality of decarbonization initiatives to consider for implementation for an enterprise;
classifying each decarbonization initiative of the plurality of decarbonization initiatives based on one or more decision types;
selecting one or more optimization objectives and associated constraints for the plurality of decarbonization initiatives;
formulating a unified optimization model based on the one or more optimization objectives and associated constraints;
solving the unified optimization model for each decarbonization initiative of the plurality of decarbonization initiatives to determine an optimized decarbonization action plan; and
funding and implementing the optimized decarbonization action plan.

10. The system of claim 9, wherein the instructions, when executed by the one or more processors, cause the computing system to perform operations comprising:
performing a benchmarking process to evaluate a plurality of mathematical programming languages and solvers in the context of the unified optimization model to automatically select a mathematical programming language and solver; and
selectively using the selected mathematical programming language and solver to solve the unified optimization model for each decarbonization initiative of the plurality of decarbonization initiatives to determine the optimized decarbonization action plan.

11. The system of claim 9, wherein the plurality of decarbonization initiatives each define a particular decarbonization technology investment initiative to be funded to provide one or more particular carbon emissions reductions to reduce overall net carbon emissions for the enterprise.

12. The system of claim 9, wherein each of the one or more decision types define:
whether the respective decarbonization initiative can be scaled;
whether the respective decarbonization initiative can be expanded, once deployed; and
whether the respective decarbonization initiative can be operated at reduced capacity.

13. The system of claim 9, wherein the instructions, when executed by the one or more processors, cause the computing system to perform operations comprising solving the unified optimization model for each decarbonization initiative of the plurality of decarbonization initiatives utilizing linear and mixed integer programming methods.

14. The system of claim 9, wherein the unified optimization model is defined by a set of linear equations to model the one or more optimization objectives and associated constraints.

15. The system of claim 9, wherein solving the unified optimization model for each decarbonization initiative of the plurality of decarbonization initiatives comprises determining a net present value and maximum emissions reduction of each decarbonization initiative over a time period.

16. The system of claim 15, wherein the instructions, when executed by the one or more processors, cause the computing system to perform operations comprising generating a decarbonization investment Pareto front for multiple objectives comprising:
maximizing the net present value of each decarbonization initiative to determine a corresponding lower bound of emissions reduction;
determining a decarbonization action plan that maximizes emissions reduction to determine a corresponding upper bound of emissions reduction;
sub-dividing the lower and upper bounds of emissions reduction into a number of emission reduction target steps; and
for each emissions reduction target step, determining a decarbonization action plan that maximizes net present value for a same or greater emissions reduction target.

17. A method to generate a decarbonization investment Pareto front for multiple objectives comprising:
maximizing, via a computing system, net present value of a plurality of selected technologies to determine a corresponding lower bound of emissions reduction;
determining, via the computing system, a decarbonization action plan that maximizes emissions reduction to determine a corresponding upper bound of emissions reduction;
sub-dividing, via the computing system, the lower and upper bounds of emissions reduction into a number of emission reduction target steps; and
for each emissions reduction target step, determining, via the computing system, a decarbonization action plan that maximizes net present value for a same or greater emissions reduction target.

18. The method of claim 17, comprising:
performing, via the computing system, a benchmarking process to evaluate a plurality of mathematical programming languages and solvers in the context of a unified optimization model used to determine the net present value and emissions reduction for the plurality of selected technologies to automatically select a mathematical programming language and solver; and
selectively using, via the computing system, the selected mathematical programming language and solver to solve the unified optimization model for each selected technology to determine an optimized decarbonization action plan.

19. The method of claim 17, wherein the plurality of selected technologies each define a particular decarbonization technology investment initiative to be funded to provide one or more particular carbon emissions reductions to reduce overall net carbon emissions for an enterprise.

20. The method of claim 17, comprising classifying each of the plurality of selected technologies based on one or more decision types that define:
whether the respective selected technology can be scaled;
whether the respective selected technology can be expanded, once deployed; and
whether the respective selected technology can be operated at reduced capacity.
